(19) United States
(12) Patent Application Publication
(10) Pub. No.: US 2015/0358786 A1
(43) Pub. Date: Dec. 10, 2015

(54) METHOD FOR TRANSMITTING/RECEIVING GROUP ADDRESSED FRAME IN WLAN SYSTEM AND DEVICE THEREFOR

(71) Applicant: LG ELECTRONICS INC., Yeongdeungpo-gu Seoul (KR)

(72) Inventors: Jeongki KIM, Seoul (KR); Jinsoo CHOI, Seoul (KR); Yongho SEOK, Seoul (KR); Hangyu CHO, Seoul (KR)

(73) Assignee: LG ELECTRONICS INC., Seoul (KR)

(21) Appl. No.: 14/762,277

(22) PCT Filed: Jan. 22, 2014
(86) PCT No.: PCT/KR2014/000621

§ 371 Date: Jul. 21, 2015

Related U.S. Application Data
(60) Provisional application No. 61/755,420, filed on Jan. 22, 2013.
(60) Provisional application No. 61/760,657, filed on Feb. 5, 2013.

(51) Int. Cl. H04W 4/06; H04W 52/02

(52) U.S. Cl. CPC H04W 4/06; H04W 52/0229; H04W 84/12

(57) ABSTRACT

The present invention relates to a wireless communication system and, more specifically, provides a method for transmitting/receiving a group addressed frame in a WLAN system and a device therefor. The method whereby a station (STA) in a WLAN system receives a group addressed frame according to one embodiment of the present invention may comprise the steps of: transmitting a first frame to an access point (AP); in response to the first frame, receiving from the AP a second frame comprising information related to the group addressed frame for a first STA; and receiving the group addressed frame from the AP on the basis of the information related to the group addressed frame.

### TECHNICAL FIELD

The present invention relates to a wireless communication system, and more particularly to a method and apparatus for transmitting/receiving a group addressed frame in a wireless LAN (WLAN) system.

### BACKGROUND ART

Various wireless communication technologies systems have been developed with rapid development of information communication technologies. WLAN technology from among wireless communication technologies allows wireless Internet access at home or in enterprises or at a specific service provision region using mobile terminals, such as a Personal Digital Assistant (PDA), a laptop computer, a Portable Multimedia Player (PMP), etc. on the basis of Radio Frequency (RF) technology.

In order to obviate limited communication speed, one of the disadvantages of WLAN, the recent technical standard has proposed an evolved system capable of increasing the speed and reliability of a network while simultaneously extending a coverage region of a wireless network. For example, IEEE 802.11n enables a data processing speed to support a maximum high throughput (HT) of 540 Mbps. In addition, Multiple Input and Multiple Output (MIMO) technology has recently been applied to both a transmitter and a receiver so as to minimize transmission errors as well as to optimize a data transfer rate.

### DISCLOSURE

### Technical Problem

Machine to Machine (M2M) communication technology has been discussed as next generation communication technology. A technical standard for supporting M2M communication in IEEE 802.11 WLAN has been developed as IEEE 802.11ah. M2M communication may sometimes consider a scenario capable of communicating a small amount of data at low speed in an environment including a large number of devices.

Communication in the WLAN system is performed in a medium shared by all devices. If the number of devices as in the case of M2M communication increases, consumption of a long time for channel access of a single device may unavoidably deteriorate the entire system throughput, and may prevent power saving of the respective devices.

A specific-type (or specific mode) station (STA) in a WLAN system can operate in a power-saving mode without receiving the beacon from an access point (AP). In the meantime, after the AP transmits a specific-type beacon, information (hereinafter referred to as a group addressed frame) regarding all STAs or a group of STAs can be transmitted, and the specific-type STA may not receive the beacon so that it does not receive the group addressed frame. If a certain STA does not receive the group addressed frame from the AP, a faulty operation or malfunction may occur in the corresponding network, or the efficiency of network resource utilization may be deteriorated.

An object of the present invention is to provide a new method for allowing a station (STA) to correctly and efficiently receive a group addressed frame.

It is to be understood that technical objects to be achieved by the present invention are not limited to the aforementioned technical objects and other technical objects which are not mentioned herein will be apparent from the following description to one of ordinary skill in the art to which the present invention pertains.

### Technical Solution

The object of the present invention can be achieved by providing a method for receiving a group addressed frame by a station (STA) in a wireless LAN (WLAN) system including: transmitting a first frame to an access point (AP); receiving a second frame having information associated with the group addressed frame for the first station (STA) from the access point (AP), upon receiving the first frame; and receiving the group addressed frame from the access point (AP) on the basis of the group addressed frame associated information.

In accordance with another aspect of the present invention, a method for transmitting a group addressed frame in an access point (AP) of a wireless LAN (WLAN) system includes: receiving a first frame from a station (STA); transmitting a second frame having information associated with the group addressed frame for the first station (STA) to the station (STA), upon receiving the first frame; and transmitting the group addressed frame to the station (STA) on the basis of the group addressed frame associated information.

In accordance with another aspect of the present invention, a station (STA) device for receiving a group addressed frame in a wireless LAN (WLAN) system includes: a transceiver; and a processor, wherein the processor transmits a first frame to an access point (AP) using the transceiver, receives a second frame having information associated with the group addressed frame for the first station (STA) from the access point (AP) upon receiving the first frame using the transceiver, and receives the group addressed frame from the access point (AP) on the basis of the group addressed frame associated information using the transceiver.

In accordance with another aspect of the present invention, an access point (AP) device for transmitting a group addressed frame in a wireless LAN (WLAN) system includes: a transceiver; and a processor, wherein the processor receives a first frame from a station (STA) using the transceiver, transmits a second frame having information associated with the group addressed frame for the first station (STA) to the station (STA) upon receiving the first frame using the transceiver, and transmits the group addressed frame to the station (STA) on the basis of the group addressed frame associated information using the transceiver.

At least one of the following items can be applied to the embodiments of the present invention.

The group addressed frame associated information may include specific information indicating the presence or absence of the group addressed frame.

The presence or absence of the group addressed frame may be indicated using any one of a duration field of the first frame, a more data (MD) field, a power management (PM) bit, and a data indication bit.

After reception of the second frame, the station (STA) may operate in a sleep mode until receiving the group addressed frame, and may awake and receive the group addressed frame at a reception time of the group addressed frame.

The second frame may further include information regarding a transmission time of the group addressed frame.

Information regarding a transmission time of the group addressed frame may be set to any one of a next TBTT (Target Beacon Transmission Time), a next Target DTIM (Delivery Traffic Indication Map) transmission time (TDTT), a timestamp, some least significant bits (LSBs) of the timestamp, an offset, and a duration value.

The second frame may further include information regarding an identifier (ID) of a group having the station (STA).

The second frame may further include page segment information.

The station (STA) configured to transmit the first frame may be a station (STA) configured to operate in a Non-TIM (Traffic Indication Map) mode.

The station (STA) having received the group addressed frame associated information may be configured to operate in a tentative TIM (Traffic Indication Map) mode.

The first frame may be set to any one of a PS (Power Save)-Poll frame, a trigger frame, a data frame, a control frame, and a management frame.

The second frame may be set to any one of an ACK (acknowledgement) frame, an NDP (Null Data Packet) ACK frame, a response frame, a data frame, a control frame, and a management frame.

It is to be understood that both the foregoing general description and the following detailed description of the present invention are exemplary and explanatory and are intended to provide further explanation of the invention as claimed.

### Advantageous Effects

As is apparent from the above description, the embodiments of the present invention can provide a new method and apparatus for allowing a station (STA) to receive a group addressed frame in a WLAN system.

It will be appreciated by persons skilled in the art that the effects that can be achieved with the present invention are not limited to what has been particularly described hereinabove and other advantages of the present invention will be more clearly understood from the following detailed description taken in conjunction with the accompanying drawings.

### DESCRIPTION OF DRAWINGS

The accompanying drawings, which are included to provide a further understanding of the invention, illustrate embodiments of the invention and together with the description serve to explain the principle of the invention.

FIG. 1 exemplarily shows an IEEE 802.11 system according to one embodiment of the present invention.

FIG. 2 exemplarily shows an IEEE 802.11 system according to another embodiment of the present invention.

FIG. 3 exemplarily shows an IEEE 802.11 system according to still another embodiment of the present invention.

FIG. 4 is a conceptual diagram illustrating a WLAN system.

FIG. 5 is a flowchart illustrating a link setup process for use in the WLAN system.

FIG. 6 is a conceptual diagram illustrating a backoff process.

FIG. 7 is a conceptual diagram illustrating a hidden node and an exposed node.

FIG. 8 is a conceptual diagram illustrating RTS (Request To Send) and CTS (Clear To Send).

FIG. 9 is a conceptual diagram illustrating a power management operation.

FIGS. 10 to 12 are conceptual diagrams illustrating detailed operations of a station (STA) having received a Traffic Indication Map (TIM).

FIG. 13 is a conceptual diagram illustrating a group-based AID.

FIG. 14 is a conceptual diagram illustrating Delivery Traffic Indication Map (DTIM) associated operation of a Non-TIM STA.

FIGS. 15 to 29 are conceptual diagrams illustrating exemplary GABU transmission/reception (Tx/Rx) operations according to an embodiment of the present invention.

FIG. 30 is a flowchart illustrating a method for transmitting/receiving a group addressed frame according to an embodiment of the present invention.

FIG. 31 is a block diagram illustrating a radio frequency (RF) device according to an embodiment of the present invention.

### BEST MODE

Hereinafter, exemplary embodiments of the present invention will be described with reference to the accompanying drawings. The detailed description, which will be disclosed along with the accompanying drawings, is intended to describe exemplary embodiments of the present invention and is not intended to describe a unique embodiment through which the present invention can be carried out. The following detailed description includes specific details in order to provide a thorough understanding of the present invention. However, it will be apparent to those skilled in the art that the present invention may be practiced without such specific details.

The embodiments of the present invention described herein below are combinations of elements and features of the present invention. The elements or features may be considered selective unless otherwise mentioned. Each element or feature may be practiced without being combined with other elements or features. Further, an embodiment of the present invention may be constructed by combining parts of the elements and/or features. Operation orders described in embodiments of the present invention may be rearranged. Some constructions or features of any one embodiment may be included in another embodiment and may be replaced with corresponding constructions or features of another embodiment.

Specific terms used in the following description are provided to aid in understanding of the present invention. These specific terms may be replaced with other terms within the scope and spirit of the present invention.

In some instances, well-known structures and devices are omitted in order to avoid obscuring the concepts of the present invention and the important functions of the structures and devices are shown in block diagram form. The same reference numbers will be used throughout the drawings to refer to the same or like parts.

The embodiments of the present invention can be supported by standard documents disclosed for at least one of wireless access systems such as the institute of electrical and electronics engineers (IEEE) 802, 3rd generation partnership project (3GPP), 3GPP long term evolution (3GPP LTE), LTE-advanced (LTE-A), and 3GPP2 systems. For steps or parts of which description is omitted to clarify the technical features of the present invention, reference may be made to these documents. Further, all terms as set forth herein can be explained by the standard documents.

The following technology can be used in various wireless access systems such as systems for code division multiple access (CDMA), frequency division multiple access (FDMA), time division multiple access (TDMA), orthogonal frequency division multiple access (OFDMA), single carrier frequency division multiple access (SC-FDMA), etc. CDMA may be implemented by radio technology such as universal terrestrial radio access (UTRA) or CDMA2000. TDMA may be implemented by radio technology such as global system for mobile communications (GSM)/general packet radio service (GPRS)/enhanced data rates for GSM evolution (EDGE). OFDMA may be implemented by radio technology such as IEEE 802.11 (Wi-Fi), IEEE 802.16 (WiMAX), IEEE 802.20, evolved-UTRA (E-UTRA), etc. For clarity, the present disclosure focuses on 3GPP LTE and LTE-A systems. However, the technical features of the present invention are not limited thereto.

Structure of WLAN System

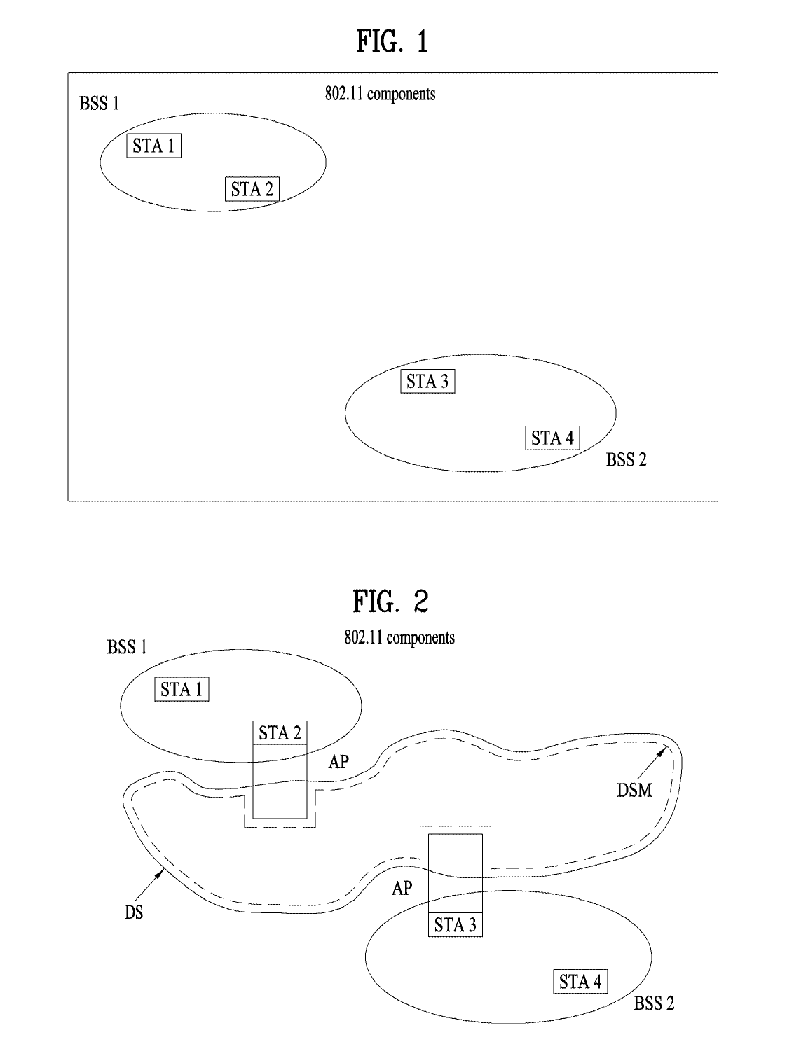

FIG. 1 is a diagram showing an exemplary structure of an IEEE 802.11 system to which the present invention is applicable.

The structure of the IEEE 802.11 system may include a plurality of components. A WLAN which supports transparent station (STA) mobility for a higher layer may be provided by mutual operations of the components. A basic service set (BSS) may correspond to a basic building block in an IEEE 802.11 LAN. In FIG. 1, two BSSs (BSS1 and BSS2) are present and two STAs are included in each of the BSSs (i.e. STA1 and STA2 are included in BSS1 and STA3 and STA4 are included in BSS2). An ellipse indicating the BSS in FIG. 1 may be understood as a coverage area in which STAs included in a corresponding BSS maintain communication. This area may be referred to as a basic service area (BSA). If an STA moves out of the BSA, the STA cannot directly communicate with the other STAs in the corresponding BSA.

In the IEEE 802.11 LAN, the most basic type of BSS is an independent BSS (IBSS). For example, the IBSS may have a minimum form consisting of only two STAs. The BSS (BSS1 or BSS2) of FIG. 1, which is the simplest form and does not include other components except for the STAs, may correspond to a typical example of the IBSS. This configuration is possible when STAs can directly communicate with each other. Such a type of LAN may be configured as necessary instead of being prescheduled and is also called an ad-hoc network.

Memberships of an STA in the BSS may be dynamically changed when the STA becomes an on or off state or the STA enters or leaves a region of the BSS. To become a member of the BSS, the STA may use a synchronization process to join the BSS. To access all services of a BSS infrastructure, the STA should be associated with the BSS. Such association may be dynamically configured and may include use of a distributed system service (DSS).

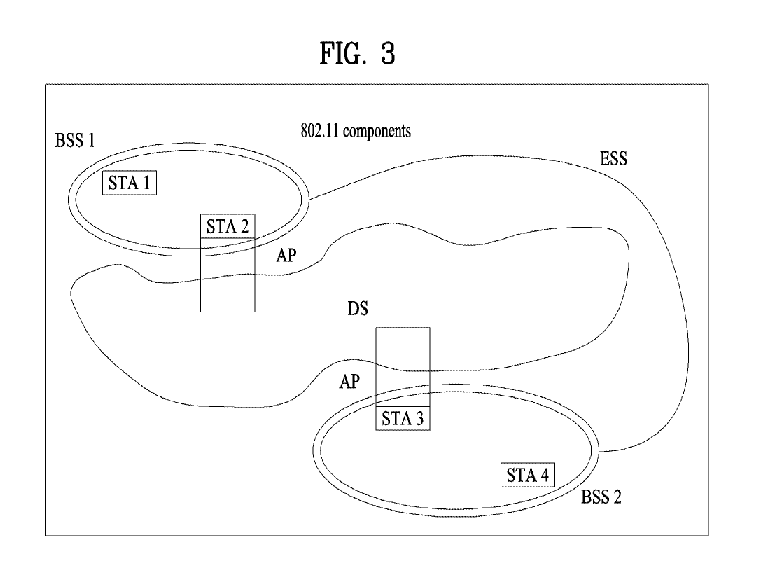

FIG. 2 is a diagram showing another exemplary structure of an IEEE 802.11 system to which the present invention is applicable. In FIG. 2, components such as a distribution system (DS), a distribution system medium (DSM), and an access point (AP) are added to the structure of FIG. 1.

A direct STA-to-STA distance in a LAN may be restricted by physical (PHY) performance. In some cases, such restriction of the distance may be sufficient for communication. However, in other cases, communication between STAs over a long distance may be necessary. The DS may be configured to support extended coverage.

The DS refers to a structure in which BSSs are connected to each other. Specifically, a BSS may be configured as a component of an extended form of a network consisting of a plurality of BSSs, instead of independent configuration as shown in FIG. 1.

The DS is a logical concept and may be specified by the characteristic of the DSM. In relation to this, a wireless medium (WM) and the DSM are logically distinguished in IEEE 802.11. Respective logical media are used for different purposes and are used by different components. In definition of IEEE 802.11, such media are not restricted to the same or different media. The flexibility of the IEEE 802.11 LAN architecture (DS architecture or other network architectures) can be explained in that a plurality of media is logically different. That is, the IEEE 802.11 LAN architecture can be variously implemented and may be independently specified by a physical characteristic of each implementation.

The DS may support mobile devices by providing seamless integration of multiple BSSs and providing logical services necessary for handling an address to a destination.

The AP refers to an entity that enables associated STAs to access the DS through a WM and that has STA functionality. Data can be moved between the BSS and the DS through the AP. For example, STA2 and STA3 shown in FIG. 2 have STA functionality and provide a function of causing associated STAs (STA1 and STA4) to access the DS. Moreover, since all APs correspond basically to STAs, all APs are addressable entities. An address used by an AP for communication on the WM need not necessarily be identical to an address used by the AP for communication on the DSM.

Data transmitted from one of STAs associated with the AP to an STA address of the AP may be always received by an uncontrolled port and may be processed by an IEEE 802.1X port access entity. If the controlled port is authenticated, transmission data (or frame) may be transmitted to the DS.

FIG. 3 is a diagram showing still another exemplary structure of an IEEE 802.11 system to which the present invention is applicable. In addition to the structure of FIG. 2, FIG. 3 conceptually shows an extended service set (ESS) for providing wide coverage.

A wireless network having arbitrary size and complexity may be comprised of a DS and BSSs. In the IEEE 802.11 system, such a type of network is referred to an ESS network. The ESS may correspond to a set of BSSs connected to one DS. However, the ESS does not include the DS. The ESS network is characterized in that the ESS network appears as an IBSS network in a logical link control (LLC) layer. STAs included in the ESS may communicate with each other and mobile STAs are movable transparently in LLC from one BSS to another BSS (within the same ESS).

In IEEE 802.11, relative physical locations of the BSSs in FIG. 3 are not assumed and the following forms are all possible. BSSs may partially overlap and this form is generally used to provide continuous coverage. BSSs may not be physically connected and the logical distances between BSSs have no limit. BSSs may be located at the same physical position and this form may be used to provide redundancy. One (or more than one) IBSS or ESS networks may be physically located in the same space as one (or more than one) ESS network. This may correspond to an ESS network form in the case in which an ad-hoc network operates in a location in which an ESS network is present, the case in which IEEE 802.11 networks different organizations physically overlap, or the case in which two or more different access and security policies are necessary in the same location.

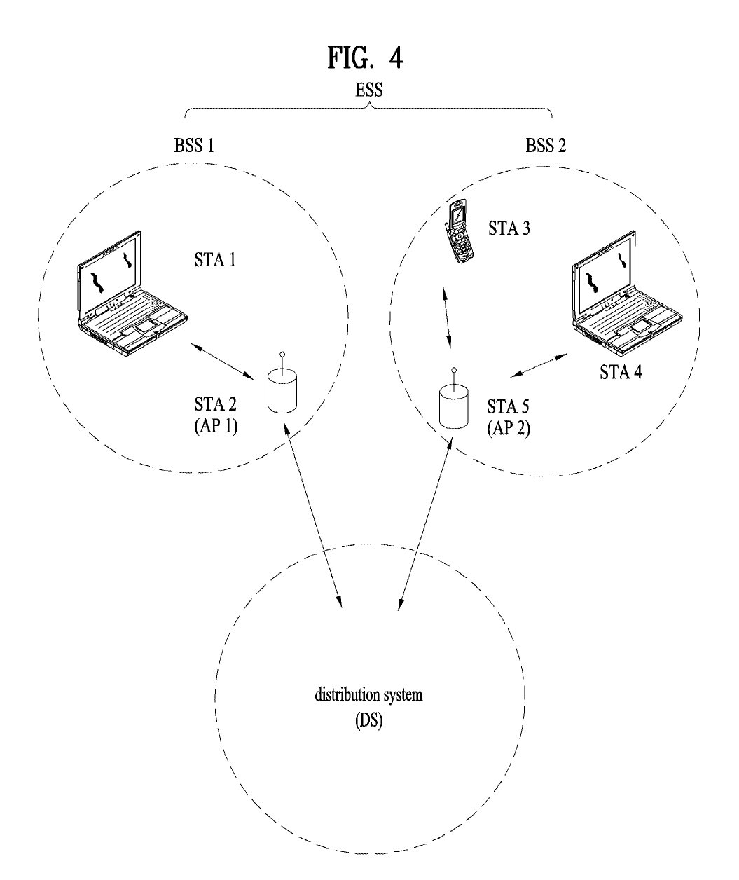

FIG. 4 is a diagram showing an exemplary structure of a WLAN system. In FIG. 4, an example of an infrastructure BSS including a DS is shown.

In the example of FIG. 4, BSS1 and BSS2 constitute an ESS. In the WLAN system, an STA is a device operating according to MAC/PHY regulation of IEEE 802.11. STAs include AP STAs and non-AP STAs. The non-AP STAs correspond to devices, such as mobile phones, handled directly by users. In FIG. 4, STA1, STA3, and STA4 correspond to the non-AP STAs and STA2 and STA5 correspond to AP STAs.

In the following description, the non-AP STA may be referred to as a terminal, a wireless transmit/receive unit (WTRU), a user equipment (UE), a mobile station (MS), a mobile terminal, or a mobile subscriber station (MSS). The AP is a concept corresponding to a base station (BS), a Node-B, an evolved Node-B (eNB), a base transceiver system (BTS), or a femto BS in other wireless communication fields.

Link Setup Process

FIG. 5 is a diagram for explaining a general link setup process.

In order to allow an STA to establish link setup on a network and transmit/receive data over the network, the STA should perform processes of network discovery, authentication, association establishment, security setup, etc. The link setup process may also be referred to as a session initiation processor or a session setup process. In addition, discovery, authentication, association, and security setup of the link setup process may also be called an association process.

An exemplary link setup process is described with reference to FIG. 5.

In step S510, an STA may perform a network discovery action. The network discovery action may include an STA scanning action. That is, in order to access the network, the STA should search for an available network. The STA needs to identify a compatible network before participating in a wireless network and the process of identifying the network present in a specific area is referred to as scanning.

Scanning is categorized into active scanning and passive scanning.

FIG. 5 exemplarily illustrates a network discovery action including an active scanning process. An STA performing active scanning transmits a probe request frame in order to determine which AP is present in a peripheral region while moving between channels and waits for a response to the probe request frame. A responder transmits a probe response frame in response to the probe request frame to the STA that has transmitted the probe request frame. Here, the responder may be an STA that has finally transmitted a beacon frame in a BSS of the scanned channel. Since an AP transmits a beacon frame in a BSS, the AP is a responder. In an IBSS, since STAs of the IBSS sequentially transmit the beacon frame, a responder is not the same. For example, an STA, that has transmitted the probe request frame at channel #1 and has received the probe response frame at channel #1, stores BSS-related information contained in the received probe response frame, and moves to the next channel (e.g. channel #2). In the same manner, the STA may perform scanning (i.e. probe request/response transmission and reception at Channel #2).

Although not shown in FIG. 5, the scanning action may also be carried out using passive scanning An STA that performs passive scanning awaits reception of a beacon frame while moving from one channel to another channel. The beacon frame is one of management frames in IEEE 802.11. The beacon frame is periodically transmitted to indicate the presence of a wireless network and allow a scanning STA to search for the wireless network and thus join the wireless network. In a BSS, an AP is configured to periodically transmit the beacon frame and, in an IBSS, STAs in the IBSS are configured to sequentially transmit the beacon frame. Upon receipt of the beacon frame, the scanning STA stores BSS-related information contained in the beacon frame and records beacon frame information on each channel while moving to another channel. Upon receiving the beacon frame, the STA may store BSS-related information contained in the received beacon frame, move to the next channel, and perform scanning on the next channel using the same method.

Active scanning is more advantageous than passive scanning in terms of delay and power consumption.

After discovering the network, the STA may perform an authentication process in step S520. The authentication process may be referred to as a first authentication process in order to clearly distinguish this process from the security setup process of step S540.

The authentication process includes a process in which an STA transmits an authentication request frame to an AP and the AP transmits an authentication response frame to the STA in response to the authentication request frame. The authentication frame used for authentication request/response corresponds to a management frame.

The authentication frame may include information about an authentication algorithm number, an authentication transaction sequence number, a state code, a challenge text, a robust security network (RSN), a finite cyclic group (FCG), etc. The above-mentioned information contained in the authentication frame may correspond to some parts of information capable of being contained in the authentication request/response frame and may be replaced with other information or include additional information.

The STA may transmit the authentication request frame to the AP. The AP may determine whether to permit authentication for the corresponding STA based on the information contained in the received authentication request frame. The AP may provide an authentication processing result to the STA through the authentication response frame.

After the STA has been successfully authenticated, an association process may be carried out in step S530. The association process includes a process in which the STA transmits an association request frame to the AP and the AP transmits an association response frame to the STA in response to the association request frame.

For example, the association request frame may include information associated with various capabilities, a beacon listen interval, a service set identifier (SSID), supported rates, supported channels, an RSN, a mobility domain, supported operating classes, a traffic indication map (TIM) broadcast request, interworking service capability, etc.

For example, the association response frame may include information associated with various capabilities, a status code, an association ID (AID), supported rates, an enhanced distributed channel access (EDCA) parameter set, a received channel power indicator (RCPI), a received signal to noise indicator (RSNI), a mobility domain, a timeout interval (association comeback time), an overlapping BSS scan parameter, a TIM broadcast response, a quality of service (QoS) map, etc.

The above-mentioned information may correspond to some parts of information capable of being contained in the association request/response frame and may be replaced with other information or include additional information.

After the STA has been successfully associated with the network, a security setup process may be performed in step S540. The security setup process of step S540 may be referred to as an authentication process based on robust security network association (RSNA) request/response. The authentication process of step S520 may be referred to as a first authentication process and the security setup process of step S540 may also be simply referred to as an authentication process.

The security setup process of step S540 may include a private key setup process through 4-way handshaking based on, for example, an extensible authentication protocol over LAN (EAPOL) frame. In addition, the security setup process may also be performed according to other security schemes not defined in IEEE 802.11 standards.

WLAN Evolution

To overcome limitations of communication speed in a WLAN, IEEE 802.11n has recently been established as a communication standard. IEEE 802.11n aims to increase network speed and reliability and extend wireless network coverage. More specifically, IEEE 802.11n supports a high throughput (HT) of 540 Mbps or more. To minimize transmission errors and optimize data rate, IEEE 802.11n is based on MIMO using a plurality of antennas at each of a transmitter and a receiver.

With widespread supply of a WLAN and diversified applications using the WLAN, the necessity of a new WLAN system for supporting a higher processing rate than a data processing rate supported by IEEE 802.11n has recently emerged. A next-generation WLAN system supporting very high throughput (VHT) is one of IEEE 802.11 WLAN systems which have been recently proposed to support a data processing rate of 1 Gbps or more in a MAC service access point (SAP), as the next version (e.g. IEEE 802.11ac) of an IEEE 802.11n WLAN system.

To efficiently utilize a radio frequency (RF) channel, the next-generation WLAN system supports a multiuser (MU)-MIMO transmission scheme in which a plurality of STAs simultaneously accesses a channel. In accordance with the MU-MIMO transmission scheme, an AP may simultaneously transmit packets to at least one MIMO-paired STA.

In addition, support of WLAN system operations in whitespace (WS) has been discussed. For example, technology for introducing the WLAN system in TV WS such as an idle frequency band (e.g. 54 to 698 MHz band) due to transition to digital TVs from analog TVs has been discussed under the IEEE 802.11af standard. However, this is for illustrative purposes only, and the WS may be a licensed band capable of being primarily used only by a licensed user. The licensed user is a user who has authority to use the licensed band and may also be referred to as a licensed device, a primary user, an incumbent user, etc.

For example, an AP and/or STA operating in WS should provide a function for protecting the licensed user. As an example, assuming that the licensed user such as a microphone has already used a specific WS channel which is a frequency band divided by regulations so as to include a specific bandwidth in the WS band, the AP and/or STA cannot use the frequency band corresponding to the corresponding WS channel in order to protect the licensed user. In addition, the AP and/or STA should stop using the corresponding frequency band under the condition that the licensed user uses a frequency band used for transmission and/or reception of a current frame.

Therefore, the AP and/or STA needs to determine whether a specific frequency band of a WS band can be used, in other words, whether a licensed user is present in the frequency band. A scheme for determining whether a licensed user is present in a specific frequency band is referred to as spectrum sensing. An energy detection scheme, a signature detection scheme, etc. are used as the spectrum sensing mechanism. The AP and/or STA may determine that the frequency band is being used by a licensed user if the intensity of a received signal exceeds a predetermined value or if a DTV preamble is detected.

Machine-to-machine (M2M) communication technology has been discussed as next generation communication technology. Technical standard for supporting M2M communication has been developed as IEEE 802.11ah in an IEEE 802.11 WLAN system. M2M communication refers to a communication scheme including one or more machines or may also be called machine type communication (MTC) or machine-to-machine communication. In this case, the machine refers to an entity that does not require direct manipulation or intervention of a user. For example, not only a meter or vending machine including a radio communication module but also a user equipment (UE) such as a smartphone capable of performing communication by automatically accessing a network without user manipulation/intervention may be machines. M2M communication may include device-to-device (D2D) communication and communication between a device and an application server. As exemplary communication between a device and an application server, communication between a vending machine and an application server, communication between a point of sale (POS) device and an application server, and communication between an electric meter, a gas meter, or a water meter and an application server. M2M communication-based applications may include security, transportation, healthcare, etc. In the case of considering the above-mentioned application examples, M2M communication has to support occasional transmission/reception of a small amount of data at low speed under an environment including a large number of devices.

More specifically, M2M communication should support a large number of STAs. Although a currently defined WLAN system assumes that one AP is associated with a maximum of 2007 STAs, methods for supporting other cases in which more STAs (e.g. about 6000 STAs) than 2007 STAs are associated with one AP have been discussed in M2M communication. In addition, it is expected that many applications for supporting/requesting a low transfer rate are present in M2M communication. In order to smoothly support these requirements, an STA in the WLAN system may recognize the presence or absence of data to be transmitted thereto based on a TIM element and methods for reducing the bitmap size of the TIM have been discussed. In addition, it is expected that much traffic having a very long transmission/reception interval is present in M2M communication. For example, a very small amount of data such as electric/gas/water metering needs to be transmitted and received at long intervals (e.g. every month). Accordingly, although the number of STAs associated with one AP increases in the WLAN system, methods for efficiently supporting the case in which there are a very small number of STAs each including a data frame to be received from the AP during one beacon period has been discussed.

As described above, WLAN technology is rapidly developing and not only the above-mentioned exemplary technologies but also other technologies including direct link setup, improvement of media streaming throughput, support of high-speed and/or large-scale initial session setup, and support of extended bandwidth and operating frequency are being developed.

Medium Access Mechanism

In a WLAN system based on IEEE 802.11, a basic access mechanism of medium access control (MAC) is a carrier sense multiple access with collision avoidance (CSMA/CA) mechanism. The CSMA/CA mechanism is also referred to as a distributed coordination function (DCF) of the IEEE 802.11 MAC and basically adopts a “listen before talk” access mechanism. In this type of access mechanism, an AP and/or an STA may sense a wireless channel or a medium during a predetermined time duration (e.g. DCF interframe space (DIFS) before starting transmission. As a result of sensing, if it is determined that the medium is in an idle status, the AP and/or the STA starts frame transmission using the medium. Meanwhile, if it is sensed that the medium is in an occupied state, the AP and/or the STA does not start its transmission and may attempt to perform frame transmission after setting and waiting for a delay duration (e.g. a random backoff period) for medium access. Since it is expected that multiple STAs attempt to perform frame transmission after waiting for different time durations by applying the random backoff period, collision can be minimized.

An IEEE 802.11 MAC protocol provides a hybrid coordination function (HCF) based on the DCF and a point coordination function (PCF). The PCF refers to a scheme of performing periodic polling by using a polling-based synchronous access method so that all reception APs and/or STAs can receive a data frame. The HCF includes enhanced distributed channel access (EDCA) and HCF controlled channel access (HCCA). EDCA is a contention based access scheme used by a provider to provide a data frame to a plurality of users. HCCA uses a contention-free based channel access scheme employing a polling mechanism. The HCF includes a medium access mechanism for improving QoS of a WLAN and QoS data may be transmitted in both a contention period (CP) and a contention-free period (CFP).

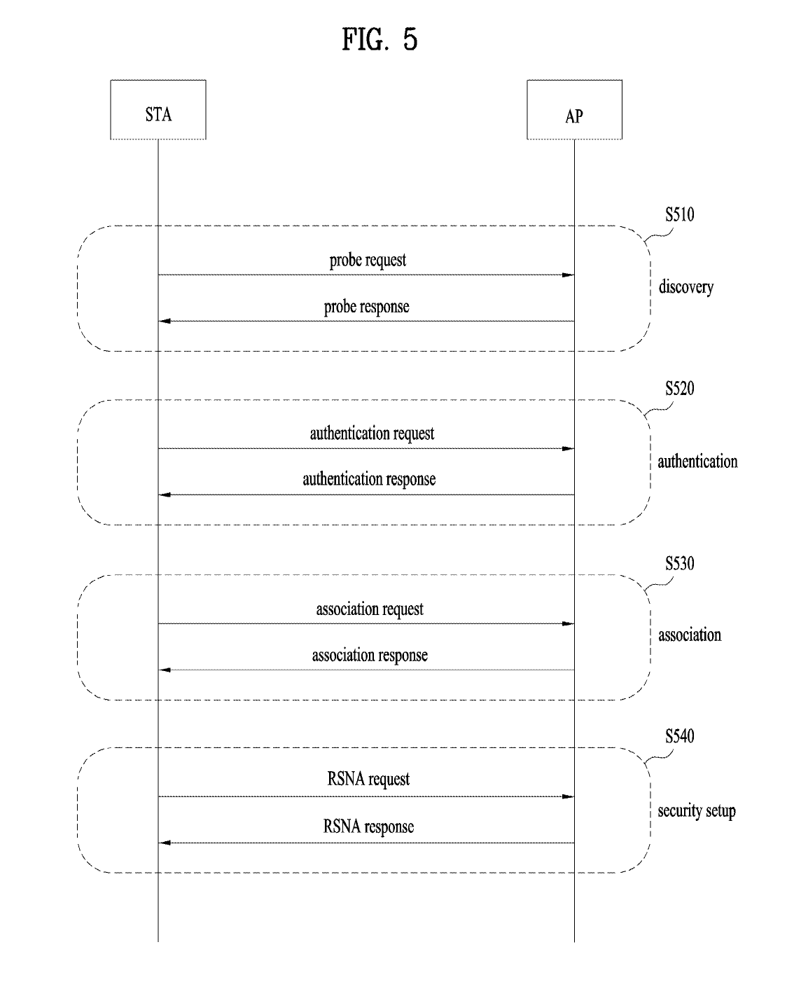

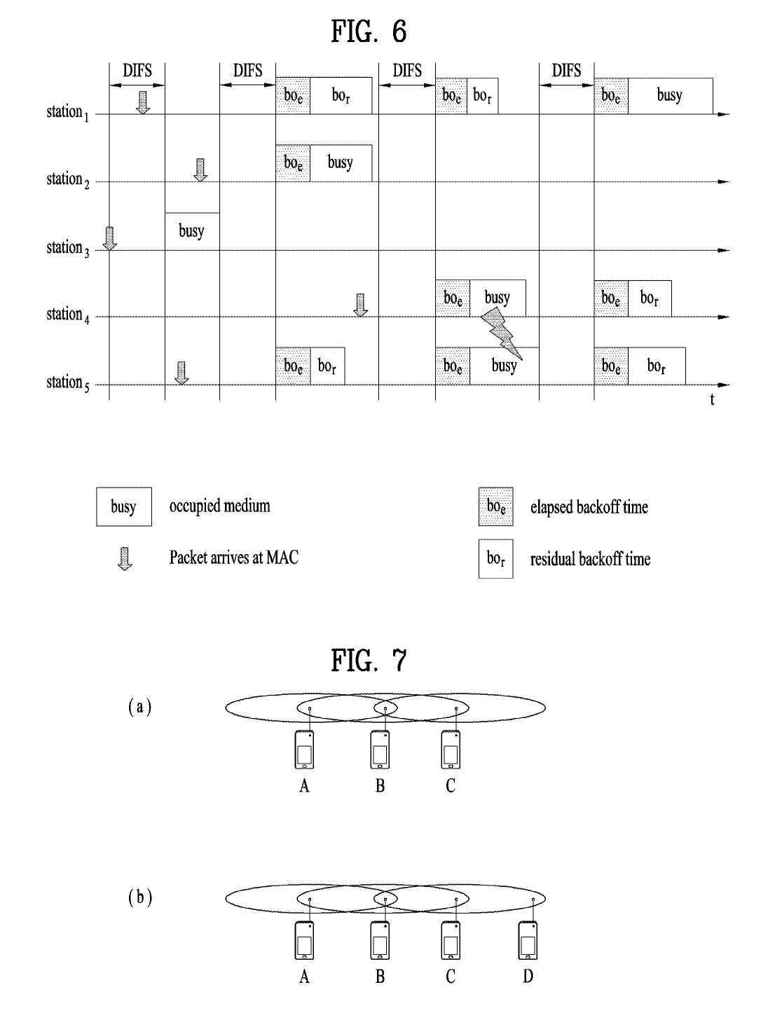

FIG. 6 is a diagram for explaining a backoff process.

Operations based on a random backoff period will now be described with reference to FIG. 6. If a medium of an occupied or busy state transitions to an idle state, several STAs may attempt to transmit data (or frames). As a method for minimizing collision, each STA may select a random backoff count, wait for a slot time corresponding to the selected backoff count, and then attempt to start data or frame transmission. The random backoff count may be a pseudo-random integer and may be set to one of 0 to CW values. In this case, CW is a contention window parameter value. Although CWmin is given as an initial value of the CW parameter, the initial value may be doubled in case of transmission failure (e.g. in the case in which ACK for the transmission frame is not received). If the CW parameter value reaches CWmax, the STAs may attempt to perform data transmission while CWmax is maintained until data transmission is successful. If data has been successfully transmitted, the CW parameter value is reset to CWmin. Desirably, CW, CWmin, and CWmax are set to 2n−1 (where n=0, 1, 2, . . . ).

If the random backoff process is started, the STA continuously monitors the medium while counting down the backoff slot in response to the determined backoff count value. If the medium is monitored as the occupied state, the countdown stops and waits for a predetermined time. If the medium is in the idle status, the remaining countdown restarts.

As shown in the example of FIG. 6, if a packet to be transmitted to MAC of STA3 arrives at STA3, STA3 may confirm that the medium is in the idle state during a DIFS and directly start frame transmission. In the meantime, the remaining STAs monitor whether the medium is in the busy state and wait for a predetermined time. During the predetermined time, data to be transmitted may occur in each of STA1, STA2, and STA5. If it is monitored that the medium is in the idle state, each STA waits for the DIFS time and then may perform countdown of the backoff slot in response to a random backoff count value selected by each STA. The example of FIG. 6 shows that STA2 selects the lowest backoff count value and STA1 selects the highest backoff count value. That is, after STA2 finishes backoff counting, the residual backoff time of STA5 at a frame transmission start time is shorter than the residual backoff time of STA1. Each of STA1 and STA5 temporarily stops countdown while STA2 occupies the medium, and waits for a predetermined time. If occupation of STA2 is finished and the medium re-enters the idle state, each of STA1 and STA5 waits for a predetermined time DIFS and restarts backoff counting. That is, after counting down the remaining backoff time corresponding to the residual backoff time, each of STA1 and STA5 may start frame transmission. Since the residual backoff time of STA5 is shorter than that of STA1, STA5 starts frame transmission. Meanwhile, data to be transmitted may occur even in STA4 while STA2 occupies the medium. In this case, if the medium is in the idle state, STA4 may wait for the DIFS time, perform countdown in response to the random backoff count value selected thereby, and then start frame transmission. FIG. 6 exemplarily shows the case in which the residual backoff time of STA5 is identical to the random backoff count value of STA4 by chance. In this case, collision may occur between STA4 and STA5. Then, each of STA4 and STA5 does not receive ACK, resulting in occurrence of data transmission failure. In this case, each of STA4 and STA5 may increase the CW value by two times, select a random backoff count value, and then perform countdown. Meanwhile, STA1 waits for a predetermined time while the medium is in the occupied state due to transmission of STA4 and STA5. If the medium is in the idle state, STA1 may wait for the DIFS time and then start frame transmission after lapse of the residual backoff time.

STA Sensing Operation

As described above, the CSMA/CA mechanism includes not only a physical carrier sensing mechanism in which the AP and/or an STA directly senses a medium but also a virtual carrier sensing mechanism. The virtual carrier sensing mechanism can solve some problems such as a hidden node problem encountered in medium access. For virtual carrier sensing, MAC of the WLAN system may use a network allocation vector (NAV). The NAV is a value used to indicate a time remaining until an AP and/or an STA which is currently using the medium or has authority to use the medium enters an available state to another AP and/or STA. Accordingly, a value set to the NAV corresponds to a reserved time in which the medium will be used by an AP and/or STA configured to transmit a corresponding frame. An STA receiving the NAV value is not allowed to perform medium access during the corresponding reserved time. For example, NAV may be set according to the value of a ‘duration’ field of a MAC header of a frame.

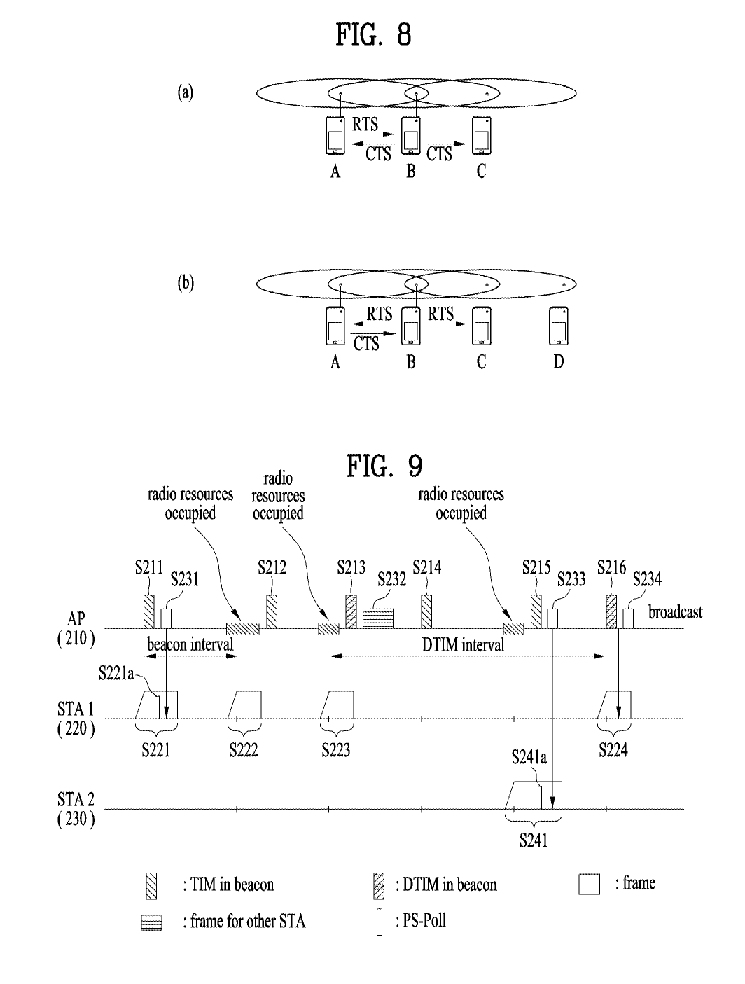

A robust collision detection mechanism has been proposed to reduce the probability of collision. This will be described with reference to FIGS. 7 and 8. Although an actual carrier sensing range is different from a transmission range, it is assumed that the actual carrier sensing range is identical to the transmission range for convenience of description.

FIG. 7 is a diagram for explaining a hidden node and an exposed node.

FIG. 7(a) exemplarily shows a hidden node. In FIG. 7(a), STA A communicates with STA B, and STA C has information to be transmitted. Specifically, STA C may determine that a medium is in an idle state when performing carrier sensing before transmitting data to STA B, although STA A is transmitting information to STA B. This is because transmission of STA A (i.e. occupation of the medium) may not be detected at the location of STA C. In this case, STA B simultaneously receives information of STA A and information of STA C, resulting in occurrence of collision. Here, STA A may be considered a hidden node of STA C.

FIG. 7(b) exemplarily shows an exposed node. In FIG. 7(b), in a situation in which STA B transmits data to STA A, STA C has information to be transmitted to STA D. If STA C performs carrier sensing, it is determined that a medium is occupied due to transmission of STA B. Therefore, although STA C has information to be transmitted to STA D, since the medium-occupied state is sensed, STA C should wait for a predetermined time until the medium is in the idle state. However, since STA A is actually located out of the transmission range of STA C, transmission from STA C may not collide with transmission from STA B from the viewpoint of STA A, so that STA C unnecessarily enters a standby state until STA B stops transmission. Here, STA C is referred to as an exposed node of STA B.

FIG. 8 is a diagram for explaining request to send (RTS) and clear to send (CTS).

To efficiently utilize a collision avoidance mechanism under the above-mentioned situation of FIG. 7, it is possible to use a short signaling packet such as RTS and CTS. RTS/CTS between two STAs may be overheard by peripheral STA(s), so that the peripheral STA(s) may consider whether information is transmitted between the two STAs. For example, if an STA to be used for data transmission transmits an RTS frame to an STA receiving data, the STA receiving data may inform peripheral STAs that itself will receive data by transmitting a CTS frame to the peripheral STAs.

FIG. 8(a) exemplarily shows a method for solving problems of a hidden node. In FIG. 8(a), it is assumed that both STA A and STA C are ready to transmit data to STA B. If STA A transmits RTS to STA B, STA B transmits CTS to each of STA A and STA C located in the vicinity of the STA B. As a result, STA C waits for a predetermined time until STA A and STA B stop data transmission, thereby avoiding collision.

FIG. 8(b) exemplarily shows a method for solving problems of an exposed node. STA C performs overhearing of RTS/CTS transmission between STA A and STA B, so that STA C may determine that no collision will occur although STA C transmits data to another STA (e.g. STA D). That is, STA B transmits RTS to all peripheral STAs and only STA A having data to be actually transmitted may transmit CTS. STA C receives only the RTS and does not receive the CTS of STA A, so that it can be recognized that STA A is located outside of the carrier sensing range of STA C.

Power Management

As described above, the WLAN system needs to perform channel sensing before an STA performs data transmission/reception. The operation of always sensing the channel causes persistent power consumption of the STA. Power consumption in a reception state is not greatly different from that in a transmission state. Continuous maintenance of the reception state may cause large load to a power-limited STA (i.e. an STA operated by a battery). Therefore, if an STA maintains a reception standby mode so as to persistently sense a channel, power is inefficiently consumed without special advantages in terms of WLAN throughput. In order to solve the above-mentioned problem, the WLAN system supports a power management (PM) mode of the STA.

The PM mode of the STA is classified into an active mode and a power save (PS) mode. The STA basically operates in the active mode. The STA operating in the active mode maintains an awake state. In the awake state, the STA may perform a normal operation such as frame transmission/reception or channel scanning. On the other hand, the STA operating in the PS mode is configured to switch between a sleep state and an awake state. In the sleep state, the STA operates with minimum power and performs neither frame transmission/reception nor channel scanning.

Since power consumption is reduced in proportion to a specific time in which the STA stays in the sleep state, an operation time of the STA is increased. However, it is impossible to transmit or receive a frame in the sleep state so that the STA cannot always operate for a long period of time. If there is a frame to be transmitted to an AP, the STA operating in the sleep state is switched to the awake state to transmit/receive the frame. On the other hand, if the AP has a frame to be transmitted to the STA, the sleep-state STA is unable to receive the frame and cannot recognize the presence of a frame to be received. Accordingly, the STA may need to switch to the awake state according to a specific period in order to recognize the presence or absence of a frame to be transmitted thereto (or in order to receive the frame if the AP has the frame to be transmitted thereto).

FIG. 9 is a diagram for explaining a PM operation.

Referring to FIG. 9, an AP 210 transmits a beacon frame to STAs present in a BSS at intervals of a predetermined time period (S211, S212, S213, S214, S215, and S216). The beacon frame includes a TIM information element. The TIM information element includes buffered traffic regarding STAs associated with the AP 210 and includes information indicating that a frame is to be transmitted. The TIM information element includes a TIM for indicating a unicast frame and a delivery traffic indication map (DTIM) for indicating a multicast or broadcast frame.

The AP 210 may transmit a DTIM once whenever the beacon frame is transmitted three times. Each of STA1 220 and STA2 222 operate in a PS mode. Each of STA1 220 and STA2 222 is switched from a sleep state to an awake state every wakeup interval of a predetermined period such that STA1 220 and STA2 222 may be configured to receive the TIM information element transmitted by the AP 210. Each STA may calculate a switching start time at which each STA may start switching to the awake state based on its own local clock. In FIG. 9, it is assumed that a clock of the STA is identical to a clock of the AP.

For example, the predetermined wakeup interval may be configured in such a manner that STA1 220 can switch to the awake state to receive the TIM element every beacon interval. Accordingly, STA1 220 may switch to the awake state when the AP 210 first transmits the beacon frame (S211). STA1 220 may receive the beacon frame and obtain the TIM information element. If the obtained TIM element indicates the presence of a frame to be transmitted to STA1 220, STA1 220 may transmit a power save-Poll (PS-Poll) frame, which requests the AP 210 to transmit the frame, to the AP 210 (S221a). The AP 210 may transmit the frame to STA1 220 in response to the PS-Poll frame (S231). STA1 220 which has received the frame is re-switched to the sleep state and operates in the sleep state.

When the AP 210 secondly transmits the beacon frame, since a busy medium state in which the medium is accessed by another device is obtained, the AP 210 may not transmit the beacon frame at an accurate beacon interval and may transmit the beacon frame at a delayed time (S212). In this case, although STA1 220 is switched to the awake state in response to the beacon interval, STA1 does not receive the delay-transmitted beacon frame so that it re-enters the sleep state (S222).

When the AP 210 thirdly transmits the beacon frame, the corresponding beacon frame may include a TIM element denoted by DTIM. The TIM element denoted by DTIM may indicate that a DTIM count field of the TIM element is set to zero “0”.

During transmission of the third beacon frame, since the busy medium state is given at an original beacon transmission time as shown in FIG. 9, AP 210 may transmit the beacon frame at a delayed time in step S213. STA1 220 is switched to the awake state in response to the beacon interval, and may obtain a DTIM through the beacon frame transmitted by the AP 210. It is assumed that DTIM obtained by STA1 220 does not have a frame to be transmitted to STA1 220 and there is a frame for another STA. In this case, STA1 220 confirms the absence of a frame to be received in the STA1 220, and re-enters the sleep state, such that the STA1 220 may operate in the sleep state. After the AP 210 transmits the beacon frame, the AP 210 transmits the frame to the corresponding STA in step S232.

In this case, after the AP 210 transmits the DTIM through the beacon frame in step S213, the AP 210 may transmit group addressed frames prior to transmission of the individual addressed frame (or unicast frame). The group addressed frame may also be referred to as any one of various terms, i.e., group addressed data, group addressed information, group addressed message, and group addressed bufferable units (BUs). The group addressed frame may correspond to a multicast frame or a broadcast frame. The term “multicast” may indicate that data is transmitted to a plurality of STAs contained in a specific group, and the term “multicast frame” may indicate that a destination address (DA) or a receiver address (RA) is set to a group address. For example, a group bit of the MAC address may be set to ‘1’ so as to indicate the group address (or multicast address). The broadcast frame may indicate a frame to be transmitted to all STAs, and the broadcast address may indicate a unique group address configured to specify all STAs. Therefore, the multicast address and/or the broadcast address (i.e., multicast/broadcast addresses) may also correspond to the group address. In this case, the multicast frame and/or the broadcast frame (i.e., multicast/broadcast frames) may also be referred to as a group addressed frame (or a group addressed message or group addressed BUs).

AP 210 fourthly transmits the beacon frame in step S214. However, it is impossible for STA1 220 to obtain information regarding the presence of buffered traffic associated with the STA1 220 through double reception of a TIM element, such that the STA1 220 may adjust the wakeup interval for receiving the TIM element. Alternatively, provided that signaling information for coordination of the wakeup interval value of STA1 220 is contained in the beacon frame transmitted by AP 210, the wakeup interval value of the STA1 220 may be adjusted. In this example, STA1 220, that has been switched to receive a TIM element every beacon interval, may be switched to another operation state in which STA1 220 can awake from the sleep state once every three beacon intervals. Therefore, when AP 210 transmits a fourth beacon frame in step S214 and transmits a fifth beacon frame in step S215, STA1 220 maintains the sleep state such that it cannot obtain the corresponding TIM element.

When AP 210 sixthly transmits the beacon frame in step S216, STA1 220 is switched to the awake state and operates in the awake state, such that the STA1 220 is unable to obtain the TIM element contained in the beacon frame in step S224. The TIM element is a DTIM indicating the presence of a broadcast frame, such that STA1 220 does not transmit the PS-Poll frame to the AP 210 and may receive a broadcast frame transmitted by the AP 210 in step S234. In the meantime, the wakeup interval of STA2 230 may be longer than a wakeup interval of STA1 220. Accordingly, STA2 230 enters the awake state at a specific time S215 where the AP 210 fifthly transmits the beacon frame, such that the STA2 230 may receive the TIM element in step S241. STA2 230 recognizes the presence of a frame to be transmitted to the STA2 230 through the TIM element, and transmits the PS-Poll frame to the AP 210 so as to request frame transmission in step S241a. AP 210 may transmit the frame to STA2 230 in response to the PS-Poll frame in step S233.

In order to operate/manage the power save (PS) mode shown in FIG. 9, the TIM element may include either a TIM indicating the presence or absence of a frame to be transmitted to the STA, or a DTIM indicating the presence or absence of a broadcast/multicast frame. DTIM may be implemented through field setting of the TIM element.

FIGS. 10 to 12 are conceptual diagrams illustrating detailed operations of a station (STA) having received a Traffic Indication Map (TIM).

Referring to FIG. 10, STA is switched from the sleep state to the awake state so as to receive the beacon frame including a TIM from the AP. The STA interprets the received TIM element such that it can recognize the presence or absence of buffered traffic to be transmitted to the STA. After STA contends with other STAs to access the medium for PS-Poll frame transmission, the STA may transmit the PS-Poll frame for requesting data frame transmission to the AP. The AP having received the PS-Poll frame transmitted by the STA may transmit the frame to the STA. The STA may receive a data frame and then transmit an ACK frame to the AP in response to the received data frame. Thereafter, the STA may re-enter the sleep state.

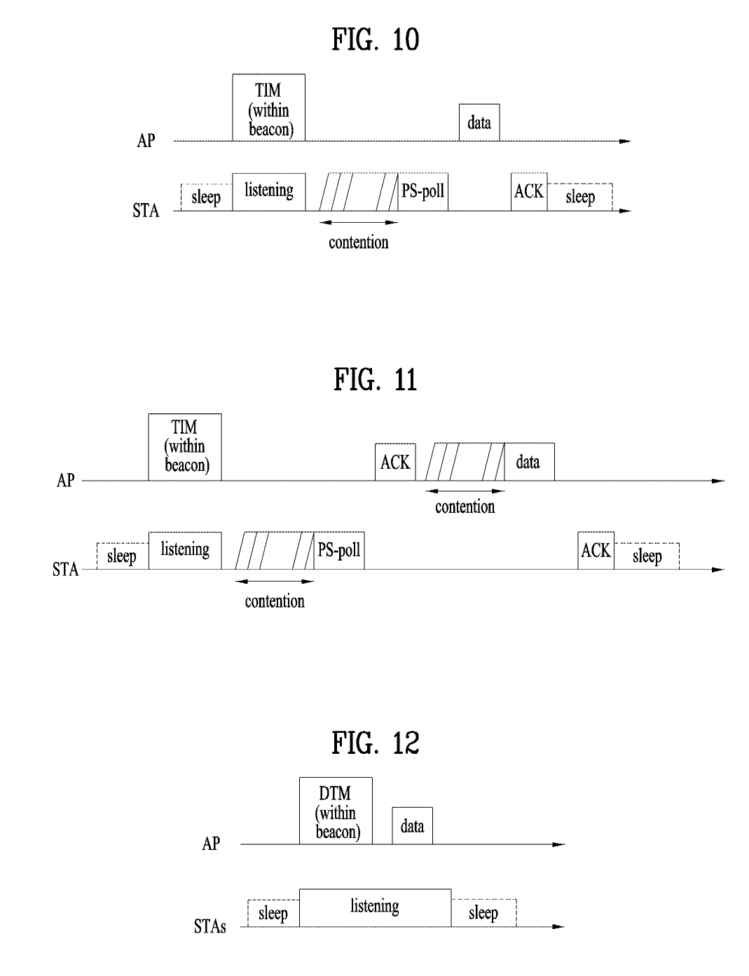

As can be seen from FIG. 10, the AP may operate according to the immediate response scheme, such that the AP receives the PS-Poll frame from the STA and transmits the data frame after lapse of a predetermined time [for example, Short Inter-Frame Space (SIFS)]. In contrast, the AP having received the PS-Poll frame does not prepare a data frame to be transmitted to the STA during the SIFS time, such that the AP may operate according to the deferred response scheme, and as such a detailed description thereof will hereinafter be described with reference to FIG. 11.

The STA operations of FIG. 11 in which the STA is switched from the sleep state to the awake state, receives a TIM from the AP, and transmits the PS-Poll frame to the AP through contention are identical to those of FIG. 10. If the AP having received the PS-Poll frame does not prepare a data frame during the SIFS time, the AP may transmit the ACK frame to the STA instead of transmitting the data frame. If the data frame is prepared after transmission of the ACK frame, the AP may transmit the data frame to the STA after completion of such contention. The STA may transmit the ACK frame indicating successful reception of a data frame to the AP, and may the transition to the sleep state.

FIG. 12 shows the exemplary case in which AP transmits a DTIM. STAs may be switched from the sleep state to the awake state so as to receive the beacon frame including a DTIM element from the AP. STAs may recognize that multicast/broadcast frame(s) will be transmitted through the received DTIM. After transmission of the beacon frame including the DTIM, AP may directly transmit data (i.e., multicast/broadcast frame) without transmitting/receiving the PS-Poll frame. While STAs continuously maintain the awake state after reception of the beacon frame including the DTIM, the STAs may receive data, and then switch to the sleep state after completion of data reception.

TIM Structure

In the operation and management method of the Power save (PS) mode based on the TIM (or DTIM) protocol shown in FIGS. 9 to 12, STAs may determine the presence or absence of a data frame to be transmitted for the STAs through STA identification information contained in the TIM element. STA identification information may be specific information associated with an Association Identifier (AID) to be allocated when an STA is associated with an AP.

The AID is used as a unique ID of each STA within one BSS. For example, the AID for use in the current WLAN system may be allocated to one of 1 to 2007. In the case of the current WLAN system, 14 bits for the AID may be allocated to a frame transmitted by AP and/or STA. Although the AID value may be assigned a maximum of 16383, the values of 2008˜16383 are set to reserved values.

The TIM element according to legacy definition is inappropriate for application of M2M application through which many STAs (for example, at least 2007 STAs) are associated with one AP. If the conventional TIM structure is extended without any change, the TIM bitmap size excessively increases, such that it is impossible to support the extended TIM structure using the legacy frame format, and the extended TIM structure is inappropriate for M2M communication in which application of a low transfer rate is considered. In addition, it is expected that there are a very small number of STAs each having reception (Rx) data frame during one beacon period. Therefore, according to exemplary application of the above-mentioned M2M communication, it is expected that the TIM bitmap size is increased and most bits are set to zero (0), such that there is needed a technology capable of efficiently compressing such bitmap.

In the legacy bitmap compression technology, successive values (each of which is set to zero) of 0 are omitted from a head part of bitmap, and the omitted result may be defined as an offset (or a start point) value. However, although STAs each including the buffered frame is small in number, if there is a high difference between AID values of respective STAs, compression efficiency is not high. For example, assuming that the frame to be transmitted to only a first STA having an AID of 10 and a second STA having an AID of 2000 is buffered, the length of a compressed bitmap is set to 1990, the remaining parts other than both edge parts are assigned zero (0). If STAs associated with one AP is small in number, inefficiency of bitmap compression does not cause serious problems. However, if the number of STAs associated with one AP increases, such inefficiency may deteriorate overall system throughput.

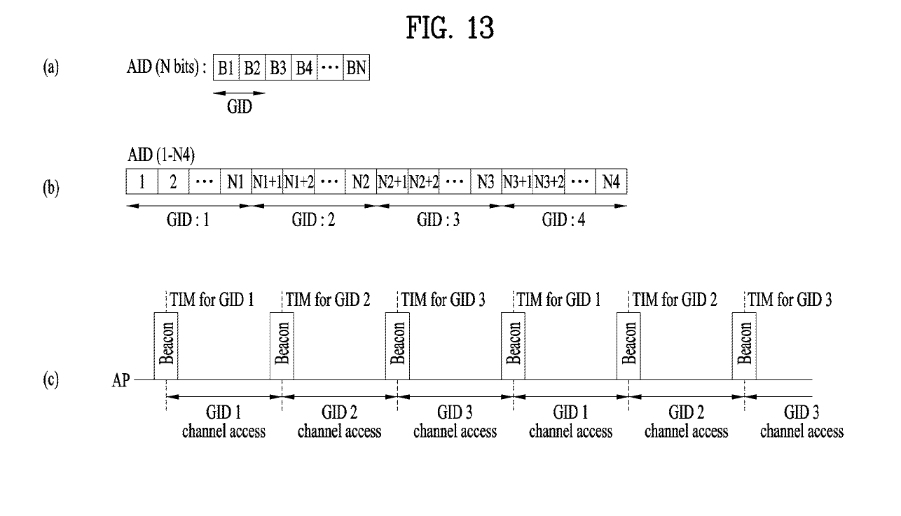

In order to solve the above-mentioned problems, AIDs may be divided into a plurality of groups such that data can be more efficiently transmitted using the AIDs. A designated group ID (GID) may be allocated to each group. AIDs allocated on the basis of such group will hereinafter be described with reference to FIG. 13.

FIG. 13(a) is a conceptual diagram illustrating an example of a group-based AID. In FIG. 13(a), some bits located at the front part of the AID bitmap may be used to indicate a group ID (GID). For example, it is possible to designate four GIDs using the first two bits of an AID bitmap. If a total length of the AID bitmap is denoted by N bits, the first two bits (B1 and B2) may represent a GID of the corresponding AID.

FIG. 13(b) is a conceptual diagram illustrating a group-based AID. In FIG. 13(b), a GID may be allocated according to the position of AID. In this case, AIDs having the same GID may be represented by offset and length values. For example, if GID 1 is denoted by Offset A and Length B, this means that AIDs (A˜A+B−1) on bitmap are respectively set to GID 1. For example, FIG. 13(b) assumes that AIDs (1˜N4) are divided into four groups. In this case, AIDs contained in GID 1 are denoted by 1˜N1, and the AIDs contained in this group may be represented by Offset 1 and Length N1. AIDs contained in GID 2 may be represented by Offset (N1+1) and Length (N2−N1+1), AIDs contained in GID 3 may be represented by Offset (N2+1) and Length (N3−N2+1), and AIDs contained in GID 4 may be represented by Offset (N3+1) and Length (N4−N3+1).

In case of using the aforementioned group-based AIDs, channel access is allowed in a different time interval according to individual GIDs, the problem caused by the insufficient number of TIM elements compared with a large number of STAs can be solved and at the same time data can be efficiently transmitted/received. For example, during a specific time interval, channel access is allowed only for STA(s) corresponding to a specific group, and channel access to the remaining STA(s) may be restricted.

Channel access based on GID will hereinafter be described with reference to FIG. 13(c). If AIDs are divided into three groups, the channel access mechanism according to the beacon interval is exemplarily shown in FIG. 13(c). A first beacon interval is a specific interval in which channel access to an STA corresponding to an AID contained in GID 1 is allowed, and channel access of STAs contained in other GIDs is disallowed. For implementation of the above-mentioned structure, a TIM element used only for AIDs corresponding to GID 1 is contained in a first beacon frame. A TIM element used only for AIDs corresponding to GID 2 is contained in a second beacon frame. Accordingly, only channel access to an STA corresponding to the AID contained in GID 2 is allowed during a second beacon interval (or a second RAW) during a second beacon interval. A TIM element used only for AIDs having GID 3 is contained in a third beacon frame, such that channel access to an STA corresponding to the AID contained in GID 3 is allowed using a third beacon interval. A TIM element used only for AIDs each having GID 1 is contained in a fourth beacon frame, such that channel access to an STA corresponding to the AID contained in GID 1 is allowed using a fourth beacon interval. Thereafter, only channel access to an STA corresponding to a specific group indicated by the TIM contained in the corresponding beacon frame may be allowed in each of beacon intervals subsequent to the fifth beacon interval.

Although FIG. 13(c) exemplarily shows that the order of allowed GIDs is periodical or cyclical according to the beacon interval, the scope or spirit of the present invention is not limited thereto. That is, only AID(s) contained in specific GID(s) may be contained in a TIM element, such that channel access to STA(s) corresponding to the specific AID(s) is allowed during a specific time interval, and channel access to the remaining STA(s) is disallowed.

The aforementioned group-based AID allocation scheme may also be referred to as a hierarchical structure of a TIM. That is, a total AID space is divided into a plurality of blocks, and channel access to STA(s) (i.e., STA(s) of a specific group) corresponding to a specific block having any one of the remaining values other than ‘0’ may be allowed. Therefore, a large-sized TIM is divided into small-sized blocks/groups, STA can easily maintain TIM information, and blocks/groups may be easily managed according to class, QoS or usage of the STA. Although FIG. 13 exemplarily shows a 2-level layer, a hierarchical TIM structure comprised of two or more levels may be configured. For example, a total AID space may be divided into a plurality of page groups, each page group may be divided into a plurality of blocks, and each block may be divided into a plurality of sub-blocks. In this case, according to the extended version of FIG. 13(a), first N1 bits of AID bitmap may represent a page ID (i.e., PID), the next N2 bits may represent a block ID, the next N3 bits may represent a sub-block ID, and the remaining bits may represent the position of STA bits contained in a sub-block.

In the examples of the present invention, various schemes for dividing STAs (or AIDs allocated to respective STAs) into predetermined hierarchical group units, and managing the divided result may be applied to the embodiments, however, the group-based AID allocation scheme is not limited to the above examples.

APSD Mechanism

An Access Point (AP) supporting Automatic Power Save Delivery (APSD) may perform signaling of information indicating that the AP supports APSD using an APSD subfield contained in a capability information field such as a beacon frame, a probe response frame, or associated response frame (or a re-associated response frame). The STA capable of supporting APSD may indicate whether to operate in the active mode or in the PS mode using the power management field contained in the FC field of the frame.

The APSD is a mechanism in which the STA operating in the PS mode can transmit DL data and a bufferable management frame. A power management bit of the FC bit of a frame transmitted by the STA operating in the PS mode employing the APSD is set to 1, such that AP buffering may be triggered.

The APSD defines two delivery mechanisms, i.e., Unscheduled-APSD (U-APSD) and Scheduled-APSD (S-APSD). The STA may use the U-APSD in such a manner that all or some parts of a Bufferable Unit (BU) can be transferred during an unscheduled service period (SP). In addition, the STA may use the S-APSD to deliver some or all parts of the BU during the scheduled SP.

In accordance with the U-APSD mechanism, the STA may inform the AP of a requested transmission duration so as to use U-APSD SP, and the AP may transmit a frame to the STA during the SP. In accordance with the U-APSD mechanism, the SSTA may simultaneously receive several PDSUs from the AP using its own SP.

The STA can recognize the presence of data to be received from the AP through a TIM element of a beacon. Thereafter, the STA transmits a trigger frame to the AP at a desired time so as to inform the AP of the beginning of STA's service period (SP), such that the STA may transmit a data transmission request to the AP. The AP may transmit ACK as a response to the trigger frame. Thereafter, the AP transmits an RTS to the STA through competition, receives a CTS frame from the STA, and transmits data to the STA. In this case, data transferred from the AP may be comprised of one or more data frames. When the AP transmits the last data frame, End Of Service Period (EOSP) of the corresponding data frame is set to 1 and is then transmitted to the STA, the STA may recognize the EOSP of 1 and terminate the SP. Therefore, the STA may transmit an ACK signal indicating successful data reception to the AP. As described above, according to the U-APSD mechanism, the STA may start its own SP at a desired time so as to receive data, and receive multiple data frames within one SP, such that it can more effectively receive data.

The STA configured to use U-APSD may not receive a frame transmitted by the AP during the service period (SP) due to interference. Although the AP may not detect interference, the AP may decide that the STA has incorrectly received the frame. Using U-APSD coexistence capability, the STA may inform the AP of a requested transmission duration, and may use the requested transmission duration as an SP for U-APSD. The AP may transmit the frame during the SP, such that the possibility of receiving the frame can increase under the condition that the STA receives interference. In addition, U-APSD may reduce the possibility that the frame transferred from the AP is not successfully received during the SP.

The STA may transmit an ADDTS (an Add Traffic Stream) request frame including a coexistence element to the AP. The U-APSD coexistence element may include information regarding the requested SP.

The AP may process a requested SP and transmit the ADDTS response frame as a response to the ADDTS request frame. The ADDTS request frame may include a status code. The status code may indicate response information of the requested SP. The status code may indicate whether or not the requested SP is allowed, and may further indicate a reason of rejection when the requested SP is rejected.

If the requested SP is allowed by the AP, the AP may transmit the frame to the STA during the SP. The duration time of SP may be specified by the U-APSD coexistence element contained in the ADDTS request frame. The beginning point of SP may be a specific time at which the STA transmits a trigger frame to the AP such that the AP is normally received.

The STA may enter a sleep state (or a doze status) when U-APSD SP expires.

PPDU Frame Format

A PPDU (Physical Layer Convergence Protocol (PLCP) Packet Data Unit) frame format may include a Short Training Field (STF), a Long Training Field (LTF), a signal (SIG) field, and a data field. The most basic (for example, non-HT) PPDU frame format may be comprised of a Legacy-STF (L-STF) field, a Legacy-LTF (L-LTF) field, an SIG field, and a data field. In addition, the most basic PPDU frame format may further include additional fields (i.e., STF, LTF, and SIG field) between the SIG field and the data field according to the PPDU frame format types (for example, HT-mixed format PPDU, HT-greenfield format PPDU, a VHT PPDU, and the like).

STF is a signal for signal detection, Automatic Gain Control (AGC), diversity selection, precise time synchronization, etc. LTF is a signal for channel estimation, frequency error estimation, etc. The sum of STF and LTF may be referred to as a PCLP preamble. The PLCP preamble may be referred to as a signal for synchronization and channel estimation of an OFDM physical layer.

The SIG field may include a RATE field, a LENGTH field, etc. The RATE field may include information regarding data modulation and coding rate. The LENGTH field may include information regarding the length of data. Furthermore, the SIG field may include a parity field, a SIG TAIL bit, etc.

The data field may include a service field, a PLCP Service Data Unit (PSDU), and a PPDU TAIL bit. If necessary, the data field may further include a padding bit. Some bits of the SERVICE field may be used to synchronize a descrambler of the receiver. PSDU may correspond to a MAC PDU (Protocol Data Unit) defined in the MAC layer, and may include data generated/used in a higher layer. A PPDU TAIL bit may allow the encoder to return to a state of zero (0). The padding bit may be used to adjust the length of a data field according to a predetermined unit.

MAC PDU may be defined according to various MAC frame formats, and the basic MAC frame is composed of a MAC header, a frame body, and a Frame Check Sequence. The MAC frame is composed of MAC PDUs, such that it can be transmitted/received through PSDU of a data part of the PPDU frame format.

On the other hand, a null-data packet (NDP) frame format may indicate a frame format having no data packet. That is, the NDP frame includes a PLCP header part (i.e., STF, LTF, and SIG fields) of a general PPDU format, whereas it does not include the remaining parts (i.e., the data field). The NDP frame may be referred to as a short frame format.

Active Polling

STA in which active polling is allowed may perform polling for AP as soon as the STA awakes. That is, the STA in which active polling is allowed may perform the polling operation (e.g., transmission of the PS-Poll frame) without listening to the beacon after being switched to an awake state. Since the STA can perform polling without confirming the TIM element contained in the beacon frame, this STA may be referred to as a Non-TIM STA. Meanwhile, if data to be transmitted to the STA according to the TIM element contained in the beacon frame, the STA performing the polling may be referred to as a TIM STA.

The active polling may be classified into a scheduled active polling type and an unscheduled active polling type.

In the case of the scheduled active polling, the AP may schedule the awake (or wakeup) time of the STA, the STA may awake from the scheduled time, may perform the UL/DL transmission operation, and need not track the beacon.

In the case of the unscheduled active polling, the AP may allow the corresponding STA or STA group to transmit the UL frame at a random time at which the STA or STA group awakes, and need not track the beacon.

Meanwhile, the active polling STA configured not to track the beacon may miss or lose information being updated through the beacon, timestamp information, etc. Therefore, if the active polling STA awakes, the active polling STA may immediately request the AP to provide the AP. The AP may immediately provide the corresponding information to the STA, or may command the STA to receive the corresponding information through the next beacon. For this purpose, the AP may also provide the STA with a timer configured to receive the next beacon.

As described above, a TIM STA awakes every listen interval, receives the beacon, and confirms the TIM contained in the beacon, such that the TIM STA operates according to the confirmed TIM. Non-TIM STA need not awake every listen interval, such that the non-TIM STA need not receive the beacon every listen interval. Therefore, Non-TIM STA may awake at a random time (e.g., during the listening interval), and may transmit the PS-Poll frame, the trigger frame, the UL data frame, or the RTS frame to the AP so as to implement data transmission/reception (Tx/Rx).

Method for Receiving Group Addressed BUs of Non-TIM STA

As described above, the group addressed BU (GABU) such as multicast/broadcast frames may be transmitted by the AP as soon as the beacon having a DTIM is transmitted. Therefore, after the STA receives a DTIM, the STA may receive a GABU burst. However, Non-TIM STA awakes every listening interval during the sleep mode such that Non-TIM STA need not receive the beacon every listening interval during the sleep mode. As a result, Non-TIM STA may not receive a GABU (for example, a broadcast frame) from the AP.

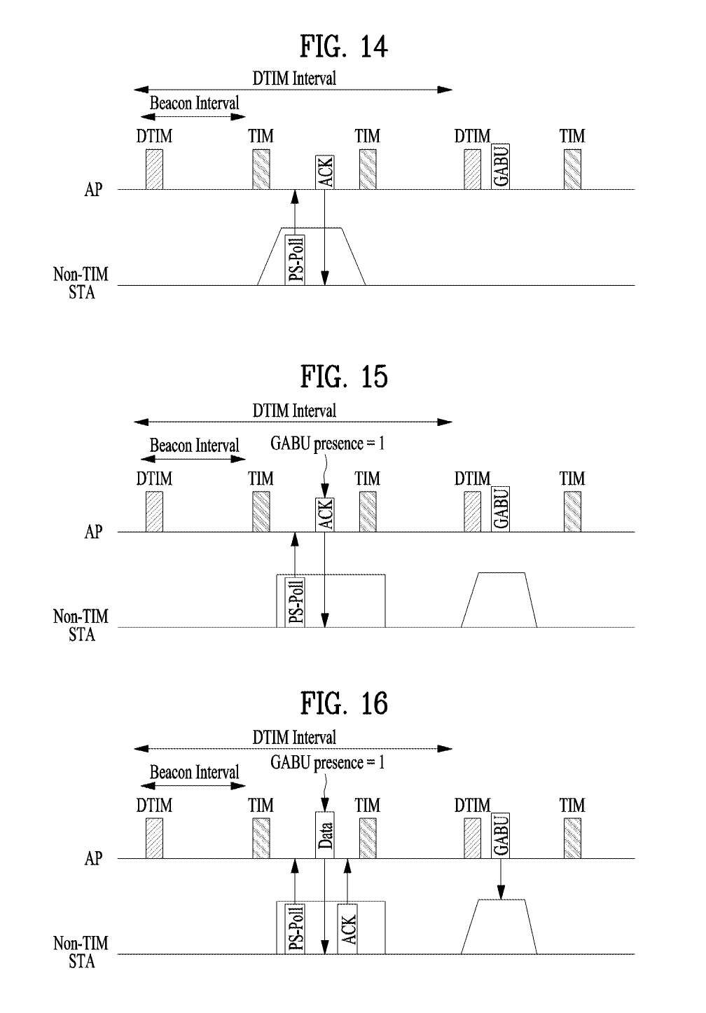

FIG. 14 is a conceptual diagram illustrating Delivery Traffic Indication Map (DTIM) associated operation of a Non-TIM STA.

In FIG. 14, assuming that a DTIM is transmitted once at intervals of three beacons, DTIM may be transmitted at a first beacon frame, and DTIM may be transmitted at a fourth beacon frame. Meanwhile, Non-TIM STA may operate in the sleep mode when the first beacon frame is transmitted from the AP, may awake at a random time (during the second beacon interval as shown in FIG. 14), and may transmit the PS-Poll frame or the like to the AP. Non-TIM STA having received the ACK frame may re-enter the sleep mode. In this case, Non-TIM STA may not receive a DTIM from the fourth beacon frame, and may not receive a GABU subsequent to the DTIM.

GABU transmitted from the AP may include important information for the Non-TIM STA, such that the Non-TIM STA having not received the important information may malfunction or may deteriorate the network efficiency. Therefore, the present invention provides a new method for allowing a STA operating in the non-TIM mode to correctly and efficiently receive the GABU from the AP.

In accordance with the present invention, assuming that Non-TIM STA having awaked from the power saving mode (or the sleep mode) transmits a first frame to the AP, if the AP having received the first frame has a GABU to be transmitted to the corresponding Non-TIM, the AP may transmit a second frame including GABU associated information to the Non-TIM STA.

For example, the first frame may be a PS-Poll frame, a trigger frame, an uplink (UL) data frame, a control frame, or a management frame. Although various embodiments of the present invention have exemplarily disclosed the PS-Poll frame, the scope or spirit of the present invention is not limited thereto.

For example, the second frame may be an ACK frame, an NDP ACK frame, a newly-defined response frame, a data frame, a control frame, or a management frame. Although various embodiments of the present invention have exemplarily disclosed the ACK frame, the scope or spirit of the present invention is not limited thereto.

The GABU associated information may include at least one of specific information indicating the presence of GABU, the corresponding group identifier (ID) (e.g., Group AID or Multicast AID), a GABU transmission time, and page segment information to be transmitted prior to GABU transmission.

Non-TIM STA may perform the following operations using the GABU associated information contained in the second frame received from the AP.

For example, if Non-TIM STA having transmitted the first frame (e.g., a PS-Poll frame) recognizes the absence of unicast DL data to be transmitted from the AP to the Non-TIM STA, the Non-TIM STA according to the conventional art may re-enter the sleep mode.

In accordance with the present invention, assuming that specific information (for example, a GABU presence field) indicating the presence or absence of GABU is contained in the second frame and the specific information indicates the presence of GABU, although unicast DL data to be received by Non-TIM STA is not present, the Non-TIM STA does not operate in the sleep mode and may stay in the awake state until GABU is received from the AP.

If GABU transmission time information (e.g., information needed for deciding an awake time so as to receive a GABU) is contained in the second frame, STA operates in the sleep mode until reaching the corresponding time, awakes from the sleep mode just before the corresponding time, and waits to receive the GABU from the AP. For example, GABU transmission time information may be denoted by a next target DTIM transmission time, a next Target Beacon Transmission Time (TBTT), or a next group addressed BU (GABU) transmission time, etc. In addition, the GABU transmission time information may be denoted by an absolute value (e.g., a timestamp value or a least significant bit (LSB) of the timestamp value) or a relative value (e.g., an offset value or a duration value on the basis of a specific time).

In addition, as described above, GABU transmission time information contained in the second frame indicates the beacon reception time as in TBTT, Non-TIM STA receives the beacon based on the indicated beacon reception time, and GABU finally receives the same beacon. The above-mentioned operation may also indicate that tentative mode switching is performed in such a manner that STA operating in the Non-TIM mode operates in a TIM mode. Assuming that the AP receives the first frame from the Non-TIM STA and a GABU to be transmitted to the corresponding Non-TIM STA is present, this means that tentative mode switching for allowing the corresponding Non-TIM STA to operate as a TIM STA through the second frame

In addition, if Non-TIM STA belongs to a GABU reception group, the corresponding group ID (e.g., Group AID) may be contained in the second frame. Therefore, Non-TIM STA may correctly receive the GABU using the group ID.

If page segment information to be transmitted prior to GABU transmission is contained in the second frame, Non-TIM STA awakes at a transmission time of the corresponding page segment and can wait for GABU reception.

Various embodiments of the present invention will hereinafter be described based on the above basic operations of AP and STA

FIG. 15 is a conceptual diagram illustrating an example of GABU transmission/reception (Tx/Rx) operations according to an embodiment of the present invention.

Referring to FIG. 15, Non-TIM STA awakes at a predetermined time (e.g., a target awake type (TWT)) or at a random time, transmits the PS-Poll frame to the AP, and determines whether or not a BU for the Non-TIM STA is present in the AP.

If the AP receives the PS-Poll frame from the Non-TIM STA, the AP may transmit an ACK frame or a data frame to the corresponding Non-TIM STA in response to the PS-Poll frame. As can be seen from FIG. 15, upon receiving the PS-Poll frame from the Non-TIM STA, the AP may transmit the ACK frame.

If the AP has GABU regarding the group including the Non-TIM STA having transmitted the PS-Poll frame, information (e.g., GABU presence field) indicating the presence or absence of GABU is contained in the ACK frame, and the resultant ACK frame can be transmitted to the corresponding Non-TIM STA. If the AP has a GABU, the GABU presence field is set to ‘1’. If the AP does not have GABU, the GABU presence field is set to zero ‘0’.

If the GABU presence field contained in the ACK frame acting as a response to the PS-Poll is set to ‘1’, Non-TIM STA may determine the presence of GABU for the Non-TIM STA. Therefore, Non-TIM STA stays in a standby mode until reaching the next beacon transmission time (i.e., Non-TIM STA maintains an awake state), such that the Non-TIM STA can receive the beacon frame. Non-TIM STA may confirm a DTIM count value included in the TIM element contained in the beacon frame, such that it can recognize the DTIM transmission time. Non-TIM STA may re-enter the sleep mode until reaching the next DTIM transmission time. Non-TIM STA having received a DTIM at the DTIM transmission time may receive the GABU from the AP in a subsequent process.

FIG. 16 is a conceptual diagram illustrating another example of GABU transmission/reception (Tx/Rx) operations according to an embodiment of the present invention.

Differently from FIG. 15, the embodiment of FIG. 16 allows the AP to transmit a data frame (e.g., unicast DL burst) instead of the ACK frame, upon receiving the PS-Poll frame from the Non-TIM STA. In addition, the embodiment of FIG. 16 may also allow the Non-TIM STA to transmit the ACK frame to the AP upon receiving the data frame from the AP.

In this case, the AP may insert specific information (e.g., GABU presence field) indicating the presence or absence of GABU into the data frame answering the PS-Poll frame received from the Non-TIM STA.

Therefore, if Non-TIM STA confirms that the GABU presence field is set to ‘1’ and determines the presence of GABU on the basis of the confirmed result, the Non-TIM STA waits for the next TBTT and then receives the beacon at the next TBTT. In addition, the Non-TIM STA confirms a DTIM transmission time (e.g., the next DTIM transmission time) on the basis of information contained in the beacon, and may enter the sleep mode. Non-TIM STA awakes at a subsequent DTIM transmission time, then receives a DTIM at the subsequent DTIM transmission time, and then receives the GABU from the AP.

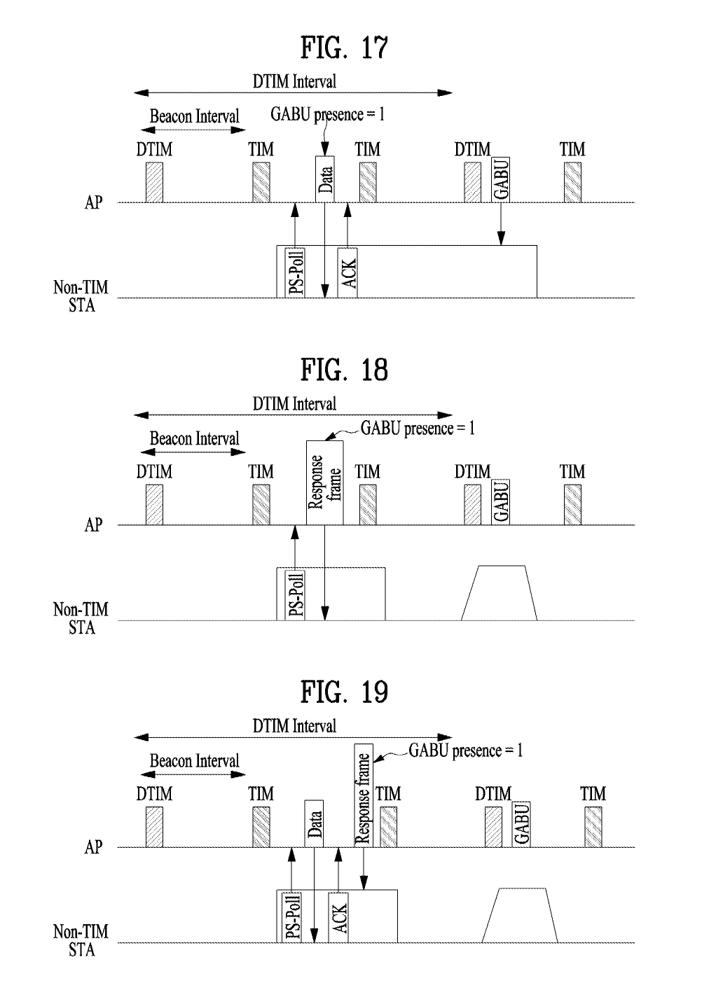

FIG. 17 is a conceptual diagram illustrating another example of GABU transmission/reception (Tx/Rx) operations according to an embodiment of the present invention.

The exchange operation of the PS-Poll frame, the data frame (e.g., unicast DL burst), and the ACK frame between the Non-STA STA and the AP shown in FIG. 17 is identical to those of FIG. 16, and as such redundant description will be omitted for clarity.

As can be seen from FIG. 17, since the GABU presence field of the data frame received from the AP is set to ‘1’, Non-TIM STA having confirmed the presence of GABU associated with the Non-TIM STA can stay in a standby mode until reaching the next DTIM transmission time. That is, the Non-TIM STA may maintain an awake state without re-entering the sleep mode until reaching the next DTIM transmission time. Therefore, the Non-TIM STA having received a DTIM may receive a GABU from the AP in a subsequent process.

FIG. 18 is a conceptual diagram illustrating another example of GABU transmission/reception (Tx/Rx) operations according to an embodiment of the present invention.

Referring to FIG. 18, as a response frame to the PS-Poll frame received from the Non-TIM STA, the AP may provide GABU associated information through the newly defined response frame, instead of the ACK frame or the data frame.

After the AP receives the PS-Poll from the Non-TIM STA, the response frame may be transmitted from the AP to the Non-TIM STA after lapse of an SIFS time. The response frame may include not only the GABU presence field, but also various information (e.g., timestamp information, TWT information, etc.) to be received by the Non-TIM STA. In addition, the response frame may also be defined as the corrected ACK frame (i.e., a frame achieved when additional information proposed by the present invention is contained in the legacy ACK frame).

Therefore, if Non-TIM STA confirms that the GABU presence field contained in the response frame is set to ‘1’ and determines the presence of GABU, the Non-TIM STA waits for the next TBTT and receives the beacon at the next TBTT, confirms a DTIM transmission time (e.g., the next DTIM transmission time) from information contained in the beacon, and thus enters the sleep mode. Non-TIM STA awakes at the next DTIM transmission time, receives a DTIM at the next DTIM transmission time, and receives the GABU from the AP in a subsequent process.

FIG. 19 is a conceptual diagram illustrating an example of GABU transmission/reception (Tx/Rx) operations according to an embodiment of the present invention.

As can be seen from FIG. 19, although the operation for allowing the Non-TIM STA and the AP to exchange the PS-Poll frame, the data frame (e.g., unicast DL burst), and the ACK frame is identical to the legacy operation, it should be noted that the response frame may be transmitted after the AP receives the ACK frame from the Non-TIM STA. The response frame may be identical to the response frame shown in FIG. 18.

Therefore, if a Non-TIM STA confirms that the GABU presence field contained in the response frame is set to ‘1’ and determines the presence of GABU, the Non-TIM STA waits for the next TBTT and receives the beacon at the next TBTT, and confirms the DTIM transmission time (e.g., the next DTIM transmission time) from information contained in the beacon and thus enters the sleep mode. Non-TIM STA awakes at the next DTIM transmission time, receives a DTIM at the next DTIM transmission time, and receives a GABU from the AP in a subsequent process.

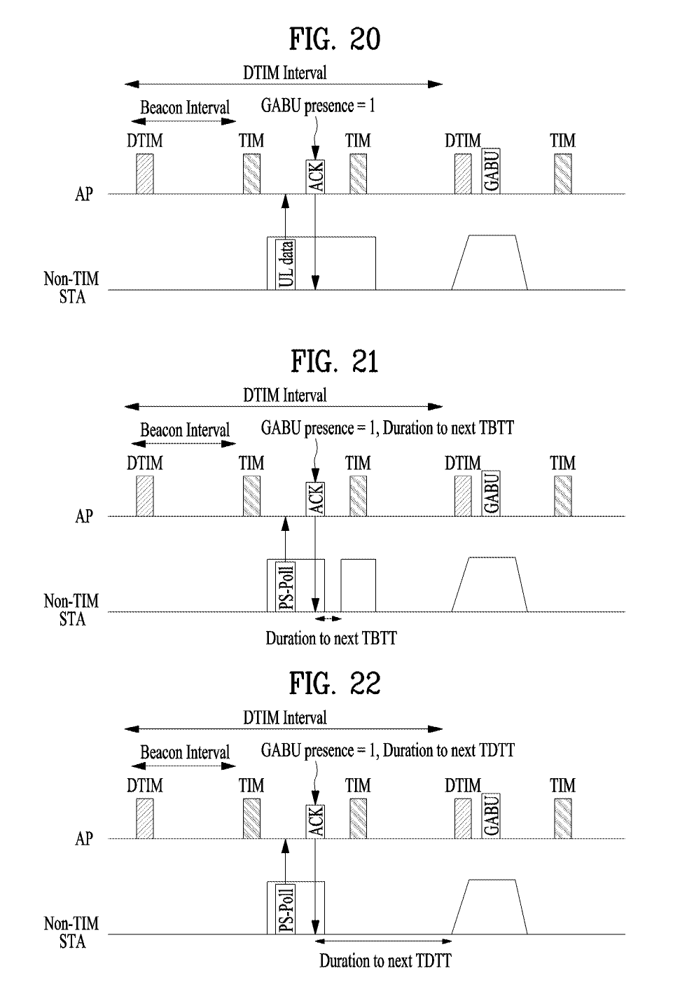

FIG. 20 is a conceptual diagram illustrating an example of GABU transmission/reception (Tx/Rx) operations according to an embodiment of the present invention.

Referring to FIG. 20, a Non-TIM STA awakes at a predetermined time (e.g., TWT) or a random time, and then transmits the data frame to the AP. If the AP receives the data frame from the Non-TIM STA, the AP may transmit the ACK frame in response to the data frame. If the AP has a GABU regarding the group having the Non-TIM STA having transmitted the data frame, information (e.g., GABU presence field) indicating the presence or absence of GABU may be contained in the ACK frame, such that the resultant ACK frame can be transmitted to the corresponding Non-TIM STA. If the GABU presence field contained in the ACK frame acting as a response to the data frame is set to ‘1’, the Non-TIM STA may determine the presence of GABU for the Non-TIM STA. Therefore, Non-TIM STA may wait for the next TBTT, receives the beacon at the next TBTT, may confirm a DTIM transmission time (e.g., the next DTIM transmission time) from information contained in the beacon, and may enter the sleep mode. Non-TIM STA awakes at the next DTIM transmission time, receives a DTIM at the next DTIM transmission time, and receives a GABU from the AP in response to the received DTIM.

FIG. 21 is a conceptual diagram illustrating another example of GABU transmission/reception (Tx/Rx) operations according to an embodiment of the present invention.

Referring to FIG. 21, the AP having received the PS-Poll frame from the Non-TIM STA shown in FIG. 15 may transmit a response frame including the GABU associated information (e.g., a GABU presence field) to the corresponding Non-TIM STA. The response frame may be an ACK frame, a data frame, or a newly defined response frame (see FIG. 18). In FIG. 21, the response frame may be an ACK frame.

In this case, the AP may additionally insert information regarding the STA awake time into an ACK frame, and may then transmit the resultant ACK frame. The STA awake time information may be contained in the ACK frame when the GABU presence field contained in the ACK frame is set to ‘1’. For example, the STA awake time information may be any one of duration information (e.g., duration to next TBTT) extended to the next TBTT, information (e.g., duration to next TDTT) regarding the beacon transmission time including the next DTIM, and information regarding the GABU transmission time (e.g., a timestamp value, some bits of the timestamp value, an offset value on the basis of a specific time, or a duration time, etc.). FIG. 21 exemplarily shows that duration information extended to the next TBTT is contained in the ACK frame transmitted from the AP to the Non-TIM ST.

Therefore, Non-TIM STA having received the ACK frame including the duration information extended to the next TBTT can also re-operate in the sleep mode until reaching the next TBTT, such that power consumption of the Non-TIM STA can be greatly reduced as compared to the example of FIG. 15. The Non-TIM STA awakes at the next TBTT, receives the beacon at the next TBTT, and confirms a DTIM count value of the TIM element contained in the beacon frame, such that the Non-TIM STA may recognize the DTIM transmission time. Non-TIM STA may re-operate in the sleep mode until reaching the next DTIM transmission time. The Non-TIM STA awakes at the DTIM transmission time and receives the DTIM at the DTIM transmission time, such that the Non-TIM STA may receive the GABU from the AP in a subsequent process.

FIG. 22 is a conceptual diagram illustrating an example of GABU transmission/reception (Tx/Rx) operations according to an embodiment of the present invention.

Referring to FIG. 22, information regarding the beacon transmission time (duration to next TDTT) having the next DTIM is contained in the ACK frame transmitted from the AP having received the PS-Poll frame from the Non-TIM STA.

Therefore, Non-TIM STA may also operate in the sleep mode until reaching the next DTIM transmission time. The Non-TIM STA awakes at a DTIM transmission time, receives a DTIM at the DTIM transmission time, and thus receives a GABU from the AP in a subsequent process.

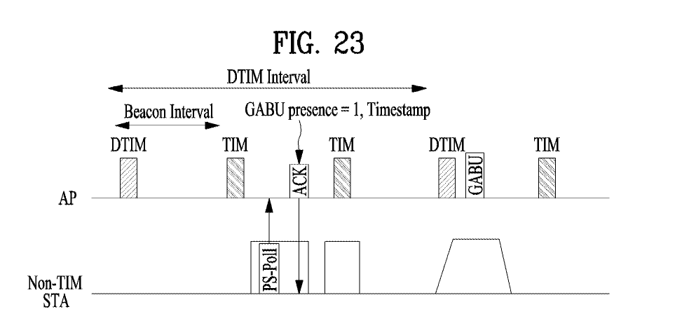

FIG. 23 is a conceptual diagram illustrating another example of GABU transmission/reception (Tx/Rx) operations according to an embodiment of the present invention.

The example of FIG. 22 shows that a timestamp value or some bits (e.g., N LSBs of Timestamp) of the timestamp value may be contained as GABU transmission time information in the ACK frame transmitted from the AP having received the PS-Poll frame from the Non-TIM STA. Although the AP provides only some LSBs of the timestamp value to the STA, if the remaining parts (e.g., MSB) remain unchanged from the timestamp value already owned by the STA, the amount of provided information can be reduced and the correct timestamp value (i.e., only a specific part to be corrected) can also be indicated.

Non-TIM STA may be synchronized with the AP on the basis of the timestamp value received from the AP. In addition, Non-TIM STA synchronized with the AP may decide/calculate the next beacon transmission time. For example, when Non-TIM STA operates in the TIM mode before operating in the Non-TIM mode (e.g., Non-TIM STA may be an STA that initially operates in the TIM mode and then operates in the Non-TIM mode), the Non-TIM STA may obtain information regarding the beacon interval from the AP and may have the obtained information. A current time is determined on the basis of the timestamp information, such that the next beacon transmission time can be calculated by applying the beacon interval to the determined time. Since the beacon interval of the AP may be changed when the AP operates in the Non-TIM mode, the AP may additionally insert the beacon interval information into timestamp information.

Therefore, Non-TIM STA having decided the next beacon transmission time may re-enter the sleep mode until reaching the next TBTT. Non-TIM STA awakes at the next TBTT, receives the beacon at the next TBTT, confirms the DTIM count value of the TIM element contained in the beacon frame, and thus recognizes the DTIM transmission time on the basis of the DTIM count value. Non-TIM STA may also operate in the sleep mode until reaching the next DTIM transmission time. The Non-TIM STA awakes at the DTIM transmission time and receives a DTIM at the DTIM transmission time, such that the Non-TIM STA can receive the GABU from the AP in a subsequent process.

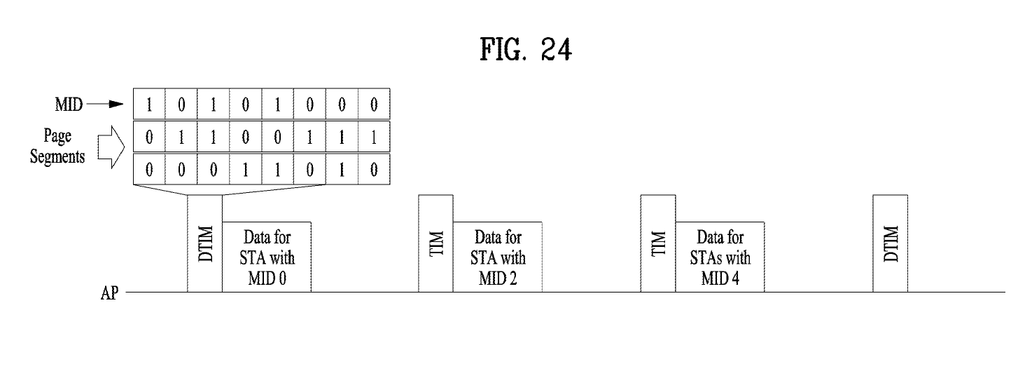

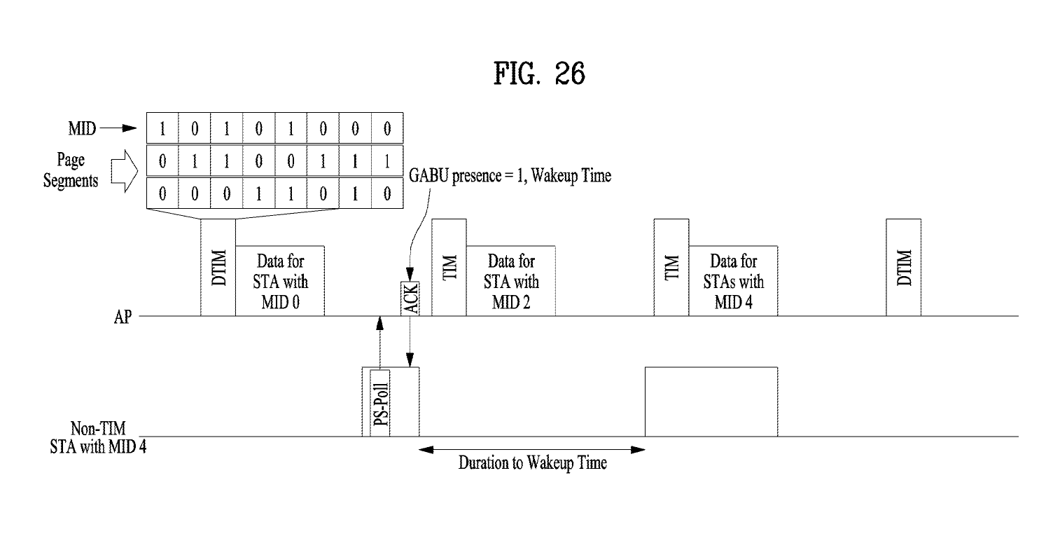

FIGS. 24 to 26 are conceptual diagrams illustrating other examples of GABU transmission/reception (Tx/Rx) operations according to an embodiment of the present invention.

In FIG. 24, a multicast AID (MID) may be an identifier (ID) for identifying each multicast group. From among 8 bits of MID, each of 0^{th}, 2^{nd}, and 4^{th} bits may be set to ‘1’, and this means transmission of the corresponding multicast group. In FIG. 24, it is assumed that data of the group corresponding to MID=0 is transmitted subsequent to DTIM, data of the group corresponding to MID=2 is transmitted subsequent to the first TIM, and data of the group corresponding to MID=4 is transmitted subsequent to the second TIM. In FIG. 24, the page segment may indicate the presence of data for STA corresponding to a certain block.

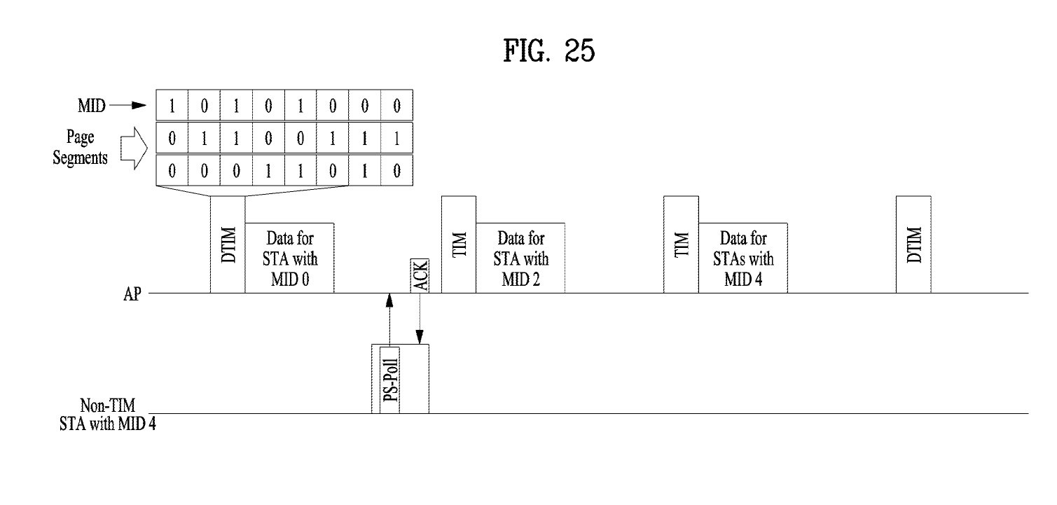

In this situation, it is assumed that, under the condition that STA of the group corresponding to MID=4 does not receive a DTIM (i.e., under the condition that the STA stays in the sleep mode at a DTIM transmission time) as shown in FIG. 25, the STA awakes and transmits the PS-Poll. In this case, although the STA does not receive the ACK frame (i.e., ACK frame of the conventional art) from the AP, the STA does not receive the DTIM, such that it is impossible for the STA to recognize the presence or absence of GABU for the STA. The STA having confirmed the absence of unicast DL data for the STA through the ACK frame may re-enter the sleep mode. Therefore, the STA may not receive the GABU (for the STA) to be transmitted subsequent to the second TIM.

In order to prevent the above-mentioned problems, GABU associated information (e.g., GABU presence field, awake time associated information, etc.) may be contained in the second frame (e.g., an ACK frame, a data frame, or a response frame) transmitted from the AP, upon receiving the first frame (e.g., PS-Poll frame or UL data frame) from the STA. For example, the awake time associated information may be information regarding a specific time at which the STA must awake again for GABU reception, and may correspond to the next beacon transmission time, the next DTIM transmission time, GABU transmission time, etc.

Therefore, the STA having received either information regarding transmission or non-transmission of GABU and/or an awake time awakes at a predetermined time, such that the STA can correctly receive GABU to be transmitted for the STA.

In accordance with the above-mentioned examples, the GABU presence field contained in the second frame may be defined as a new field that is 1 bit long. For example, the legacy field defined in the ACK frame may be reused, or some bits of the legacy defined field may also be reused as necessary.

For example, the last field (i.e., Bit 15) of the duration field contained in the ACK frame and the data frame, etc. transmitted from the AP may be reserved. In more detail, the legacy duration field may be defined as shown in the following Table 1.

TABLE 1

| Bits 0-13 | Bit 14 | Bit 15 | Usage |
|---|---|---|---|
| 0-32 767 | | 0 | Duration value (in microseconds) |
| | | | within all frames other than PS-Poll |
| | | | frames transmitted during the CP, |
| | | | and under HCF for frames |
| | | | transmitted during the CFP |
| 0 | 0 | 1 | Fixed value under point |
| | | | coordination function (PCF) within |
| | | | frames transmitted during the CFP |
| 1-16 383 | 0 | 1 | Reserved |
| 0 | 1 | 1 | Reserved |
| 1-2007 | 1 | 1 | AID in PS-Poll frames |
| 2008-16 383 | 1 | 1 | Reserved |

GABU presence information and awake time offset information for GABU reception may be defined by correcting/reusing some bits of the duration field shown in Table 1.

In accordance with a first method, the presence of GABU may indicate that a value of ‘Bit 15’ of the duration field is set to 1 (i.e., Bit 15=1), and the awake time offset may be represented using all or some parts of Bits 0˜14 of the duration field. For example, the awake time offset value may be indicated using values of 1˜16383 capable of being denoted using Bits 0˜13 of the duration field.

In accordance with a second method, the presence of GABU may indicate that the value of ‘Bit 15’ of the duration field is set to 1 and the value of ‘Bit 14’ is set to zero ‘0’ (i.e., Bit 15=1 and Bit 14=0). In addition, the awake time offset may be represented using all or some parts of Bits 0˜13 of the duration field. For example, the awake time offset may be represented using the values of 1˜16383 capable of being denoted using Bits 0˜13 of the duration field.

In accordance with a third method, the presence of GABU may indicate the case in which the value of ‘Bit 15’ of the duration field is set to 1 and the value of ‘Bit 14’ is set to 1 (i.e., Bit 15=1 and Bit 14=1). In addition, the awake time offset may be represented using all or some parts of Bits 0˜13 of the duration field. For example, the awake time offset may be represented using some values of 2008˜16383 reserved from among all the values 1˜16383 capable of being represented using Bits 1˜13 of the duration field.

In addition, even in the case of using the NDP ACK frame as the second frame, the GABU presence field may be defined as a new field being 1 bit long, and may be defined reusing the legacy field. For example, the presence or absence of GABU may be indicated using at least one MSB and/or at least one LSB of the legacy duration field. In addition, the awake time offset may be indicated using the remaining bits other than bit(s) indicating the presence or absence of GABU in the duration field.

In addition, even when the second frame is defined as a new response frame that has not been defined in the conventional art, the GABU presence field and/or the awake time offset field may also be defined as a new field.

Additional examples of the method in which the AP informs the STA of the presence or absence of GABU will hereinafter be described in detail.

If the AP receives the first frame (e.g., PS-Poll frame) from a Non-TIM STA, and if the AP has a GABU to be transmitted to the corresponding STA, the AP may use the legacy field or bit defined in the second frame (e.g., ACK frame, NDP ACK frame, or data frame).

For example, according to the first method, the More Data (MD) field of the ACK frame or the data frame may be used, or a data indication bit of the NDP ACK frame may be used.

In the legacy PS-Poll process, if the AP transmits the ACK frame in response to the PS-Poll frame from the STA, and if a buffered unit (i.e., unicast DL data) to be transmitted is present, the AP may set the value of the MD field contained in the Frame Control (FC) field of the ACK frame to the value of 1. If the buffered unit is not present, the AP may set the MD field to the value of zero ‘0’. In accordance with the present invention, although unicast DL data to be transmitted from the AP to the STA is not present, if GABU to be transmitted to the corresponding STA is present, the MD bit may be set to ‘1’.

In the data frame acting as a response to the PS-Poll frame, the MD bit may indicate the presence or absence of a buffered unit (i.e., unicast DL data) to be transmitted to the corresponding STA. Under the condition that the AP having received the PS-Poll frame from the STA immediately transmits the data frame, although unicast DL data to be transmitted to the corresponding STA is not present, if a GABU to be transmitted to the corresponding STA is present, the MD field of the data frame may be set to ‘1’.

One bit (e.g., the data indication bit) contained in the SIG field for use in the NDP ACK frame may indicate the presence or absence of a buffered unit (i.e., unicast DL data). Under the condition that the AP having received the PS-Poll from the STA transmits the NDP ACK frame, although unicast DL data to be transmitted to the corresponding STA is not present, if GABU to be transmitted to the corresponding STA is present, the data indication bit contained in the SIG filed may be set to ‘1’.

In addition, the AP may inform the STA of the presence or absence of GABU using some fields/bits (e.g., the MD field or the data indication bit) of the second frame (e.g., ACK frame, data frame, or NDP ACK frame), and at the same time the AP may also inform the STA of the GABU transmission time information (e.g., information regarding a GABU reception time of the STA). The STA may perform the power saving operation using the GABU transmission time information. That is, the STA operates in the sleep mode until reaching the GABU reception time, awakes and attempts to receive the GABU. This GABU transmission time information may be any one of the next TBTT, the next TDTT, and the next GABU transmission time. In addition, the GABU transmission time information may also be represented by an absolute value (e.g., a timestamp value, some bits (LSBs) of the timestamp value) or a relative value (e.g., an offset value or duration value on the basis of a specific time).

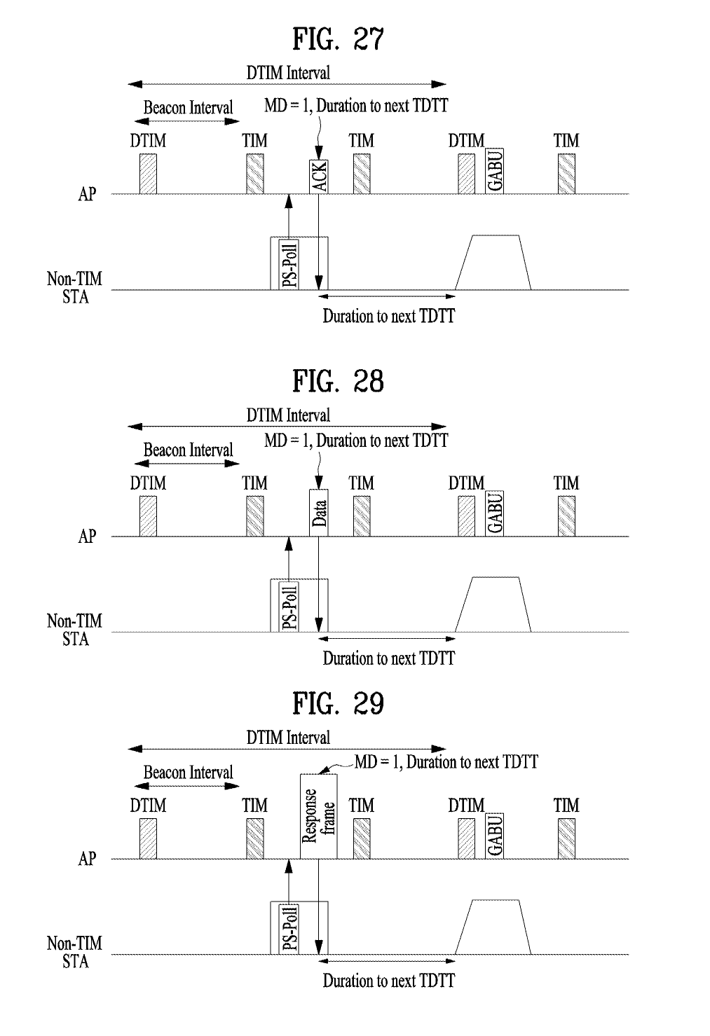

FIGS. 27 to 29 are conceptual diagrams illustrating other examples of GABU transmission/reception (Tx/Rx) operations according to an embodiment of the present invention.

If Non-TIM STA awakes and transmits the PS-Poll frame to the AP, the AP may transmit the ACK frame (see FIG. 27), the data frame (see FIG. 28) or the response frame (see FIG. 29) in response to the PS-Poll frame. In addition, if the MD bit of the ACK frame/data frame/response frame is set to 1, the STA may recognize that unicast DL data for the STA is present or the GABU is present. In addition, if GABU transmission time information (e.g., information regarding the duration extending to the next TDTT) is contained in the ACK frame/data frame/response frame, STA may determine the presence of GABU to be used for the STA. That is, the STA having received the ACK frame, the data frame, and the response frame in which the MD field is set to 1 can attempt to receive the unicast DL data in the same manner as in the conventional art. If information regarding the GABU transmission time is additionally included, although the unicast DL data is not present, the STA may recognize the presence of GABU and may then operate on the recognized result. Therefore, the STA operates in the sleep mode until reaching the next DTIM transmission time, awakes and receives the DTIM, and then receives a GABU in a subsequent process.

In addition, if Non-TIM STA awakes and transmits the PS-Poll frame to the AP, the AP may transmit the ACK frame (see FIG. 27), the data frame (see FIG. 28), or the response frame (see FIG. 29) in response to the PS-Poll frame. In this case, if the MD bit of the ACK frame, the data frame, and the response frame is set to ‘1’, the STA may recognize the presence of unicast DL data related to the STA or the presence of GABU. In addition, if a Power Management (PM) bit of the frame control (FC) field of the second frame (e.g., ACK frame, data frame, and response frame) answering the first frame is set to zero ‘0’, this means the presence of unicast DL data. If the PM bit is set to ‘1’, this means the presence of GABU. If the MD bit indicates the presence of DL data for the STA, and if the PM bit indicates that DL data is a GABU, the STA may operate in the sleep mode until reaching the next DTIM transmission time, awakes and receives a DTIM, and receives a GABU in a subsequent process.

In addition, if the MD (More Data) bit contained in the FC (Frame Control) field of the second frame (e.g., ACK frame, data frame, response frame) answering the first frame is set to ‘1’, this means the presence of unicast DL data. If the MD bit is set to zero ‘0’, this means the absence of unicast DL data. In addition, if the PM (Power Management) bit of the FC field of the second frame is set to zero ‘0’, the STA may recognize the absence of GABU. If the PM bit is set to ‘1’, the STA may recognize the presence of GABU. For example, if the MD bit is set to 0 and the PM bit is set to zero ‘0’, this means that the unicast DL data and the GABU are not present. If the MD bit is set to ‘1’ and the PM bit is set to zero ‘0’, this means that only unicast DL data is present. If the MD bit is set to zero ‘0’ and the PM bit is set to ‘1’, this means that only GABU is present. If the MD bit is set to ‘1’ and the PM bit is set to ‘1’, this means that both unicast DL data and GABU are present.

Although FIG. 27 exemplarily shows the ACK frame, the data frame, and the response frame, the NDP ACK frame may be used instead of using the ACK frame, the data frame, and the response frame. In this case, the presence or absence of GABU may be indicated using the data indication bit of the NDP ACK frame.

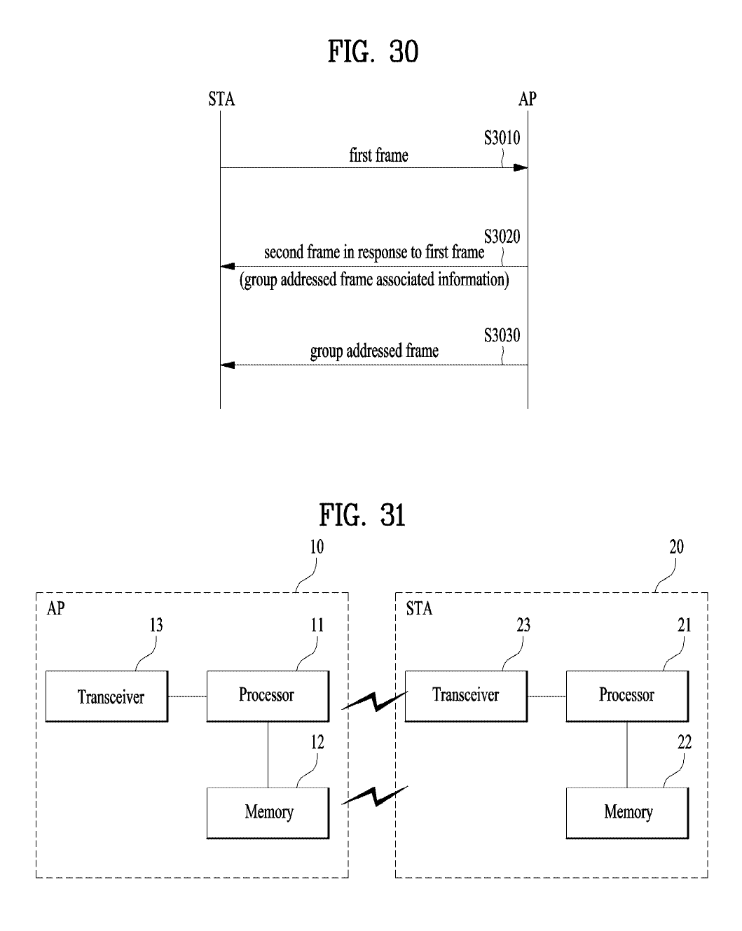

FIG. 30 is a flowchart illustrating a method for transmitting/receiving a group addressed frame according to an embodiment of the present invention.

Referring to FIG. 30, the STA may transmit the first frame (e.g., PS-Poll frame) to the AP in step S3110. The STA configured to transmit the first frame may operate in the Non-TIM mode, awakes at a TWT or a random time, and immediately transmits the first frame after passing through a backoff process.

The AP may transmit the second frame (e.g., ACK frame) in response to the first frame in step S3020. The second frame may include group addressed frame (GABU) associated information (e.g., specific information indicating the presence or absence of GABU). That is, the STA according to the conventional art may recognize the presence or absence of GABU associated with the STA through only the beacon frame having a DTIM. In the conventional art, the beacon frame is not transmitted in response to a certain frame, is used not only as an unsolicited frame to be transmitted in an unsolicited state, but also as a broadcast frame to be transmitted to all STAs, differently from the second frame of the present invention. In contrast, according to the present invention, the STA can recognize the presence or absence of GABU associated with the STA without confirmation of the DTIM.

The AP may transmit the group addressed frame to the STA in step S3030. The STA may receive the group addressed frame using the group addressed frame associated information (e.g., information for indicating the presence or absence of GABU, information associated with the GABU transmission time) received in step S3020.

Although not shown in FIG. 30, the AP having received the first frame may confirm/determine whether the frame associated with a group having the above STA is present or not. In addition, the STA may also operate in the sleep mode during all or some of a time between the step S3020 and the step S3030.

Although the exemplary method shown in FIG. 30 is represented by a series of operations for clarity of description, this method is not used to limit the execution order of steps, and individual steps may be performed at the same time or in different orders as necessary. In addition, all steps shown in FIG. 30 are not always needed to implement the method proposed by the present invention.

In accordance with the above-mentioned method of the present invention, various embodiments of the present invention are performed independently or two or more embodiments of the present invention are performed simultaneously.

FIG. 31 is a block diagram illustrating a radio frequency (RF) device according to an embodiment of the present invention.

Referring to FIG. 31, an AP 10 may include a processor 11, a memory 12, and a transceiver 13. An STA 20 may include a processor 21, a memory 22, and a transceiver 13. The transceivers 13 and 23 may transmit/receive radio frequency (RF) signals and may implement a physical layer according to an IEEE 802 system. The processors 11 and 21 are connected to the transceivers 13 and 21, respectively, and may implement a physical layer and/or a MAC layer according to the IEEE 802 system. The processors 11 and 21 can be configured to perform operations according to the above-described embodiments of the present invention. Modules for implementing operation of the AP and STA according to the above described various embodiments of the present invention are stored in the memories 12 and 22 and may be implemented by the processors 11 and 21. The memories 12 and 22 may be included in the processors 11 and 21 or may be installed at the exterior of the processors 11 and 21 to be connected by a known means to the processors 11 and 21.

STA 10 may be configured to receive a group addressed frame in a WLAN system. The processor 11 of the STA 10 may be configured to transmit a first frame to the AP 20 using the transceiver 23. In addition, the processor 11 may be configured to receive a second frame responding to the first frame from the AP 20 using the transceiver 23, and information associated with the group addressed frame for the STA 10 may be contained in the second frame. In addition, the processor 11 may receive the group addressed frame from the AP 20 using the transceiver 23 on the basis of the group addressed frame associated information.

AP 20 may be configured to transmit the group addressed frame in the WLAN system. The processor 21 of the AP 20 may be configured to receive a first frame from the STA 10 using the transceiver 23. In addition, the processor 21 may be configured to transmit a second frame responding to the first frame to the STA 10 using the transceiver 23, and information associated with the group addressed frame for the STA 10 may be contained in the second frame. In addition, the processor 21 may transmit the group addressed frame to the STA 10 using the transceiver 23 on the basis of the group addressed frame associated information.

The specific configuration of the AP and STA devices may be implemented such that the various embodiments of the present invention are performed independently or two or more embodiments of the present invention are performed simultaneously. Redundant matters will not be described herein for clarity.

The above-described embodiments of the present invention can be implemented by a variety of means, for example, hardware, firmware, software, or a combination thereof.

In the case of implementing the present invention by hardware, the present invention can be implemented with application specific integrated circuits (ASICs), Digital signal processors (DSPs), digital signal processing devices (DSPDs), programmable logic devices (PLDs), field programmable gate arrays (FPGAs), a processor, a controller, a microcontroller, a microprocessor, etc.

If operations or functions of the present invention are implemented by firmware or software, the present invention can be implemented in the form of a variety of formats, for example, modules, procedures, functions, etc. Software code may be stored in a memory to be driven by a processor. The memory may be located inside or outside of the processor, so that it can communicate with the aforementioned processor via a variety of well-known parts.

The detailed description of the exemplary embodiments of the present invention has been given to enable those skilled in the art to implement and practice the invention. Although the invention has been described with reference to the exemplary embodiments, those skilled in the art will appreciate that various modifications and variations can be made in the present invention without departing from the spirit or scope of the invention described in the appended claims. For example, those skilled in the art may use each construction described in the above embodiments in combination with each other. Accordingly, the invention should not be limited to the specific embodiments described herein, but should be accorded the broadest scope consistent with the principles and novel features disclosed herein.

### INDUSTRIAL APPLICABILITY

Although the above various embodiments of the present invention have been described based upon an IEEE 802.11 system, the embodiments may be applied in the same manner to various mobile communication systems.

1. A method for receiving a group addressed frame by a station (STA) in a wireless LAN (WLAN) system, comprising:
transmitting a first frame to an access point (AP);
receiving a second frame having information associated with the group addressed frame for the first station (STA) from the access point (AP), upon receiving the first frame; and
receiving the group addressed frame from the access point (AP) on the basis of the group addressed frame associated information.

2. The method according to claim 1, wherein the group addressed frame associated information includes specific information indicating the presence or absence of the group addressed frame.

3. The method according to claim 2, wherein the presence or absence of the group addressed frame is indicated using any one of a duration field of the first frame, a more data (MD) field, a power management (PM) bit, and a data indication bit.

4. The method according to claim 1, wherein:
after reception of the second frame, the station (STA) operates in a sleep mode until receiving the group addressed frame, and awakes and receives the group addressed frame at a reception time of the group addressed frame.

5. The method according to claim 1, wherein the second frame further includes information regarding a transmission time of the group addressed frame.

6. The method according to claim 4, wherein information regarding a transmission time of the group addressed frame is set to any one of a next TBTT (Target Beacon Transmission Time), a next Target DTIM (Delivery Traffic Indication Map) transmission time (TDTT), a timestamp, some least significant bits (LSBs) of the timestamp, an offset, and a duration value.

7. The method according to claim 1, wherein the second frame further includes information regarding an identifier (ID) of a group having the station (STA).

8. The method according to claim 1, wherein the second frame further includes page segment information.

9. The method according to claim 1, wherein the station (STA) configured to transmit the first frame is a station (STA) configured to operate in a Non-TIM (Traffic Indication Map) mode.

10. The method according to claim 8, wherein the station (STA) having received the group addressed frame associated information is configured to operate in a tentative TIM (Traffic Indication Map) mode.

11. The method according to claim 1, wherein the first frame is set to any one of a PS (Power Save)-Poll frame, a trigger frame, a data frame, a control frame, and a management frame.

12. The method according to claim 1, wherein the second frame is set to any one of an ACK (acknowledgement) frame, an NDP (Null Data Packet) ACK frame, a response frame, a data frame, a control frame, and a management frame.

13. A method for transmitting a group addressed frame in an access point (AP) of a wireless LAN (WLAN) system, comprising:
receiving a first frame from a station (STA);
transmitting a second frame having information associated with the group addressed frame for the first station (STA) to the station (STA), upon receiving the first frame; and
transmitting the group addressed frame to the station (STA) on the basis of the group addressed frame associated information.

14. A station (STA) device for receiving a group addressed frame in a wireless LAN (WLAN) system, comprising:
a transceiver; and
a processor,
wherein the processor transmits a first frame to an access point (AP) using the transceiver, receives a second frame having information associated with the group addressed frame for the first station (STA) from the access point (AP) upon receiving the first frame using the transceiver, and receives the group addressed frame from the access point (AP) on the basis of the group addressed frame associated information using the transceiver.

15. An access point (AP) device for transmitting a group addressed frame in a wireless LAN (WLAN) system, comprising:
a transceiver; and
a processor,
wherein the processor receives a first frame from a station (STA) using the transceiver, transmits a second frame having information associated with the group addressed frame for the first station (STA) to the station (STA) upon receiving the first frame using the transceiver, and transmits the group addressed frame to the station (STA) on the basis of the group addressed frame associated information using the transceiver.
